(19) United States
(12) Patent Application Publication
(10) Pub. No.: US 2018/0339597 A1
(43) Pub. Date: Nov. 29, 2018

(54) CHARGING CONNECTOR

(71) Applicant: Martin Kruszelnicki, Santa Monica, CA (US)

(72) Inventor: Martin Kruszelnicki, Santa Monica, CA (US)

(21) Appl. No.: 16/010,317

(22) Filed: Jun. 15, 2018

Related U.S. Application Data
(63) Continuation-in-part of application No. 15/987,689, filed on May 23, 2018.
(60) Provisional application No. 62/603,288, filed on May 23, 2017.
(60) Provisional application No. 62/603,945, filed on Jun. 16, 2017.
(60) Provisional application No. 62/603,946, filed on Jun. 16, 2017.

(51) Int. Cl. B60L 11/18

(52) U.S. Cl. CPC B60L 11/1818; B60L 11/1833; H02J 7/0042; B60L 2230/16; B60L 11/185

(57) ABSTRACT

A charging station system for charging an electric vehicle includes a charging station having a controller configured to control charging of an electric vehicle, and an in-ground charging connector moveable between stowed and deployed configurations. The charging station is configured for connection to an MV electrical grid, and the controller is configured to charge a battery of an electric vehicle operationally engaging the charging station. The in-ground charging connector includes at least one charging post vertically movable between stowed and deployed positions. The at least one charging post is configured to operationally engage the electric vehicle in the deployed position to charge a battery of the electrical vehicle, and is generally disposed below a ground surface upon which the electric vehicle rests when the at least one post is in the stowed position.

### RELATED APPLICATIONS

This application is a continuation-in-part of U.S. Non-provisional application Ser. No. 15/987,689, filed May 23, 2018, and also claims the benefit of and priority to U.S. Provisional Application Ser. No. 62/603,288, filed May 23, 2017, U.S. Provisional Application Ser. No. 62/603,945, filed Jun. 16, 2017, and U.S. Provisional Application Ser. No. 62/603,946, filed Jun. 16, 2017, the entire contents of which are hereby incorporated herein by reference.

### BACKGROUND

The present invention relates generally to a charging station. More particularly, the present invention relates to a charging connector of a charging station for an electric vehicle.

Traditional internal combustion engine motor vehicles (e.g., automobiles, trucks, and the like) have dominated transportation for the better part of a century. These traditional internal combustion motor vehicles, however, are powered by fossil fuels (e.g., gasoline). Fossil fuels are known contributors to air pollution and climate change. In recent decades, alternatives to traditional internal combustion engine motor vehicles have arisen (e.g., electric vehicles (“EV”), and gasoline-electric hybrid (“Hybrid”) vehicles) as a way to mitigate climate change, air pollution, and the like. These alternative vehicles use rechargeable batteries to provide power for operation of the alternative vehicle (e.g., moving the vehicle) and powering various systems within the alternative vehicle. Individual batteries may be placed together within a battery pack.

An EV or hybrid battery pack performs the same function as a gasoline tank in a conventional vehicle. That is, the battery pack stores the energy needed to operate the EV or hybrid vehicle. The battery pack can include a number of rechargeable batteries (e.g., Lithium (Li) ion batteries (LIBs), Li-metal polymer batteries (LMPBs), Lithium nickel cobalt aluminum oxide (NCA) batteries, etc.). Gasoline tanks store the energy (i.e., liquid gasoline) needed to drive an internal combustion vehicle 300-500 miles before refilling. In contrast, current generation batteries for EV offer battery capacities for driving only 50-200 miles in affordable electric vehicles, and up to a maximum of 335 miles in expensive luxury electric vehicles.

Different types of charging stations associated with electric and hybrid (e.g., plug-in hybrid) vehicles have been proposed. However, such charging stations have their limitations and can always be improved.

Current charging technology used for fast charging EVs is based on a methodology involving direct current (DC) charging at a constant current/constant voltage (CC/CV). CC/CV charging takes a longer time (i.e., multiples of the amount of time required to fill-up a conventional internal combustion engine vehicle's gas tank with gasoline), and can create excessive heat in the batteries of the EV. Excessive heat in the batteries of an EV can cause accelerated aging of the batteries as well as capacity loss in those batteries. The loss of capacity in the batteries translates into reduced mileage the EV can travel when fully-charged. An EV charging station based on DC fast charging at CC/CV rates can deliver around 125 kW power which, at this power level, requires at least forty-five (45) minutes to recharge just 80% of the vehicle battery's storage capacity. Thus, for EVs to become competitive with internal combustion engine powered vehicles, further reduction is required in charging times of EVs. Therefore, EV DC charging (via CC/CV charging) also has its limitations and EV DC charging can always be improved.

Different types of charging connectors for charging stations associated with electric and hybrid (e.g., plug-in hybrid) vehicles have been proposed. However, such charging connectors have their limitations and can always be improved.

Accordingly, there is a need for an improved charging connector for charging an electric vehicle or a hybrid vehicle. There is also a need for a charging connector that provides reduction in charging times. There is an additional need for a charging connector that does not require a driver to exit the vehicle to charge the vehicle. There is a further need for a charging connector that is easier to manufacture, assemble, adjust, and maintain. The present invention satisfies these needs and provides other related advantages.

### SUMMARY

The charging connector illustrated herein provides an improved charging connector for a charging station. The charging connector illustrated herein provides an improved charging connector for charging an electric vehicle or hybrid vehicle. The charging connector illustrated herein provides reduction in charging times. The charging connector illustrated herein does not require the driver to exit the vehicle to charge the vehicle. The charging connector illustrated herein is easier to manufacture, assemble, adjust, and maintain.

A 480V three-phase power supply is a promising technology for the widespread use of EVs. However, current industry strategies (e.g., low voltage and continuous current charging protocols) to achieve fast charging accelerate degradation mechanisms of the battery cells, increase the need for cooling of both the battery packs and the charging cables, and cannot replenish more than 10% of the total range in less than 10 minutes, with the most common recharging period being around 15 minutes (providing only ˜88 miles range). These limitations, for example, can be caused by usage of Lithium battery chemistry that is subject to gassing and overheating at fast recharge rates, vehicle powertrain limitation to a 300-400V nominal voltage architecture, hardware limitation in the cable connectors, and power electronics that interface with the standard electrical grid, usually 480V. Fast charging stations (e.g., such as Level 3 charging (also known as DC fast charging), Combined Charging System (CCS), CHAdeMO (the trade name of a quick charging method for battery electric vehicles delivering up to 62.5 kW of DC (500 V, 125 A) via a special electrical connector), or Tesla Supercharger (120 kW)) experience excessive heat generation during charging, and also require several costly power electronics modules to convert the power from the electrical grid to a useful level for the EV.

Direct connection to a Medium Voltage (MV) Grid (e.g., 5 kV˜35 kV) offers very high-power levels enabling fast and efficient charging of EVs. As disclosed herein, an improved charging station system connects to an MV electrical grid; providing a fast charging capability with a reduced battery recharge time as compared to traditional EV charging systems. An improved charging station is capable of charging EV with nominal voltage of 300-950V with a voltage output of around 1,000V and a current level of around 1,000 amps (A) such that the charging station is capable of outputting 1 MW of power at any given time. For example, an EV capable of receiving charge from the improved charging station includes an electric-powertrain capable of operating at a nominal voltage of 800V and an on-board battery capable of accepting charge at such nominal voltage, and the battery is capable of extreme fast charging/discharging. An improved charging station system can also include a direct connection to the MV electrical grid, power regulation on primary side of a main transformer, simplified power electronics, an automated, optional direct-connected vehicle coupling technology, and optional local energy storage for grid leveling and stabilization.

The charging station can be directly coupled to the EV via a coupling mechanism that electro-mechanically engages a battery interface on the EV. The battery interface on the EV provides a receptacle capable of receiving the 1,000 A continuous current delivered by the charge coupler, and then passed through this direct electro-mechanical connection of the charging station and EV to the EV's battery for charging without needing additional cooling (other than any pre-existing battery cooling system already on-board the EV).

According to another embodiment, an in-ground conductive charge coupler can be used to deliver power from the electric grid to the vehicle/battery. The in-ground conductive charge coupler and the battery interface on the EV can be aligned via an auto-park feature to position the EV over the charge coupler without a user having to exit the EV. In one particular embodiment, the in-ground conductive coupler can plug into a bottom of the EV, with a portion of the charge coupler extending upwards to engage the EV.

According to yet another embodiment, a user can select an up to MV grid connection node (e.g., 5 kV˜35 kV), and a power electronic system for up to 1 MW, high power-factor, low harmonic distortion, AC-DC conversion to charge a battery with 800V and/or 400V and other nominal DC voltages in programmable constant-current and pulse-current modes.

In accordance with another embodiment, an improved charging station can achieve the highest efficiency, highest reliability, and lowest cost step-down for AC voltage by using line-frequency transformers or pulse transformers or other transformer types to bring the AC voltage to an intermediate voltage. In particular, an intermediate voltage of 1-4 kV can be used, depending on design optimization for the power electronics (including active and passive components) of the charging station. At up to 1 MW delivered to the EV, the charging station system provides extremely fast charging of the battery, the highest efficiency, and the lowest cost for a charging station system having such power output.

In an embodiment of the present invention, a pulse charging algorithm is used by a charging station to provide faster charging of an EV battery by utilization of a millisecond charging/discharging method or algorithm instead of a CC/CV charging method. This algorithm provides greater C-rate charging without damaging or prematurely aging battery cells. The pulse charging algorithm described herein allows depolarization of electrodes in the EV battery or battery pack; enabling reduced internal resistance because of removal of polarization component of the resistance. An embodiment of the charging station will have the ability to further accelerate charging using a pulse charging algorithm that defeats the charge polarization component of the battery internal resistance and increase in temperature. As such, replenishment of as much as three hundred fifty (350) miles range in nine (9) minutes can be achieved using the pulse charging algorithm, which is faster than current re-fueling times of any EV and close to the time required to refuel an internal combustion engine automobile. Greater or smaller mileage can be achieved depending on battery chemistry, battery cell configuration, and nominal voltage. For example, 350 miles can be achieved for a 145 kWh battery pack in an EV passenger car.

In an illustrative embodiment, a charging station system for charging an electric vehicle includes a charging station having a controller configured to control charging of an electric vehicle, and an in-ground charging connector moveable between stowed and deployed configurations. The charging station is configured for connection to an MV electrical grid, and the controller is configured to charge a battery of an electric vehicle operationally engaging the charging station. The in-ground charging connector includes at least one charging post vertically movable between stowed and deployed positions. The at least one charging post is configured to operationally engage the electric vehicle in the deployed position to charge a battery of the electrical vehicle, and is generally disposed below a ground surface upon which the electric vehicle rests when the at least one post is in the stowed position.

In accordance with another embodiment, the charging station is configured to auto-park the electric vehicle over the in-ground charging connector for alignment of the at least one charging post with a charging receptacle on a bottom side of the electric vehicle.

In accordance with an additional embodiment, the charging connector is configured to deliver a pulse charge to the battery of the electric vehicle.

In accordance with a further embodiment, the at least one charging post includes a contact pad configured to provide low resistance engagement with the electric vehicle.

In accordance with yet another embodiment, the at least charging one post comprises a first charging post configured for engagement with the electric vehicle as a positive terminal and a second charging post configured for engagement with the electrical vehicle as a negative terminal, and the charging connector further includes a ground post vertically movable between stowed and deployed positions, the ground post being configured for engagement with the electric vehicle in the deployed position as a ground terminal, and wherein the ground post is generally disposed below a ground surface upon which the electric vehicle rests in the stowed position.

In accordance with another embodiment, the charging connector further includes a housing within which the at least one post is disposed when the at least one post is in the stowed position.

In accordance with still another embodiment, the charging system further includes a charging receptacle on the electric vehicle including a positive terminal, and a negative terminal; wherein the charging receptacle is configured for engaging the at least one charging post. The charging receptacle includes a housing having an aperture, the positive and negative terminals being disposed within the housing, and wherein the at least one charging post extends through the aperture to engage the positive and negative terminals. The housing includes an access plate configured for moving between open and closed positions. The access plate slidably moves along a track between then open and closed positions.

In accordance with an embodiment, a method for charging an electric vehicle by a charging station for recharging an electric vehicle battery includes establishing communication between the charging station and the electric vehicle. The electric vehicle is positioned over a charging connector, and the charging connector is vertically deployed to engage the electric vehicle. The electric vehicle is then charged.

In accordance with yet another embodiment of the method, positioning the electric vehicle further includes automatically aligning the electric vehicle with the charging station.

In accordance with another embodiment, the method further includes automatically aligning the charging connector with a charging receptacle on the electric vehicle; automatically engaging the charging connector with the charging receptacle; automatically delivering power to the battery; and automatically disengaging the charging connector from the charging receptacle when the electric vehicle battery is charged to a particular level of charge.

In accordance with yet another embodiment, establishing communication further includes wirelessly communicating information between the electric vehicle and the charging station.

In accordance with still another embodiment, establishing communication further comprises communicating vehicle-specific information from the electric vehicle to the charging station.

In accordance with a further embodiment, the method further includes monitoring charge status of the electric vehicle battery.

In accordance with another embodiment, vertically deploying the charging connector includes vertically moving the charging connector from a stowed position below a ground surface upon which the electric vehicle rests to a deployed position wherein the charging connector operationally engages a charging receptacle on the electric vehicle.

In accordance with an additional embodiment, charging the electric vehicle includes delivering a vehicle-specific rate of charge and a vehicle-specific capacity of charge to the electric vehicle battery.

In accordance with another embodiment, the charging connector includes a first charging post configured for engagement with a charging receptacle of the electric vehicle as a positive terminal and a second charging post configured for engagement with the charging receptacle of the electrical vehicle as a negative terminal.

In accordance with yet another embodiment, the charging connector further includes a ground post vertically movable between stowed and deployed positions, the ground post being configured for engagement with the electric vehicle in the deployed position as a ground terminal, and wherein the ground post is generally disposed below a ground surface upon which the electric vehicle rests in the stowed position.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The various present embodiments now will be discussed in detail with an emphasis on highlighting the advantageous features with reference to the drawings of various embodiments. The illustrated embodiments are intended to illustrate, but not to limit the invention. These drawings include the following figures, in which like numerals indicate like parts:

FIG. 1 illustrates a diagram of a charging station system, in accordance with an embodiment of the present invention;

FIG. 2 illustrates a diagram of a charging station system, in accordance with another embodiment of the present invention;

FIG. 3 illustrates an example of a pulse charging algorithm suitable for accelerated charging of lithium-ion batteries, in accordance with an embodiment of the present invention; and

FIGS. 4A and 4B illustrate an example of multiple EVs using different EV technologies being recharged at the same time by a charging station system using multiple charging stations, in accordance with an embodiment of the present invention;

FIGS. 5A and 5B illustrate an example of an EV being recharged by a charging station system using an in-ground charging connector, in accordance with an embodiment of the present invention, with the charging connector seen in a stowed configuration in FIG. 5A and in a deployed configuration in FIG. 5B;

FIG. 6 illustrates a cross-sectional view of an EV being recharged by a charging station system using an in-ground charging connector with charging posts in a deployed position engaging a charging receptacle or battery interface on a bottom side of the EV, in accordance with an embodiment of the present invention;

FIG. 7 illustrates a perspective view of the in-ground charging connector of FIG. 6, with one of the charging posts seen in a generally deployed position, the other charging post seen in a generally stowed position, and a ground post seen in a generally stowed position;

FIG. 8 illustrates another perspective view of a portion of the in-ground charging connector of FIG. 6 (various parts having been omitted for clarity), with one of the charging posts seen in a deployed position and the other charging post seen in a stowed position;

FIG. 9 illustrates a portion of the in-ground charging connector of FIG. 8 taken from another perspective (various parts having been omitted for clarity), with one of the charging posts seen in a deployed position and the other charging post seen in a stowed position;

FIG. 10 illustrates still another portion of the in-ground charging connector of FIG. 8 taken from yet another perspective (various parts having been omitted for clarity), with one of the charging posts seen in a deployed position;

FIG. 11 illustrates a cross-sectional view of the in-ground charging connector taken along line 11-11 of FIG. 10;

FIG. 12 illustrates another portion of the in-ground charging connector of FIG. 8 taken from another perspective (various parts having been omitted for clarity), with one of the charging posts seen in a deployed position;

FIGS. 13A and 13B illustrate perspective views of a charging receptacle or battery interface of an EV, in accordance with an embodiment of the invention, with an access door shown in a generally closed position in FIG. 13A and the access door shown in a generally open position in FIG. 13B; and

FIGS. 14A and 14B illustrate respective cross-section views of the battery interface of FIGS. 13A and 13B.

### DETAILED DESCRIPTION

The following detailed description describes present embodiments with reference to the drawings. In the drawings, reference numbers label elements of present embodiments. These reference numbers are reproduced below in connection with the discussion of the corresponding drawing features.

It is to be understood that the figures and descriptions of the present invention have been simplified to illustrate elements that are relevant for a clear understanding of the present invention, while eliminating, for the purpose of clarity, many other elements found in charging station systems. Those of ordinary skill in the pertinent arts may recognize that other elements and/or steps are desirable and/or required in implementing one or more embodiments of the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the pertinent arts.

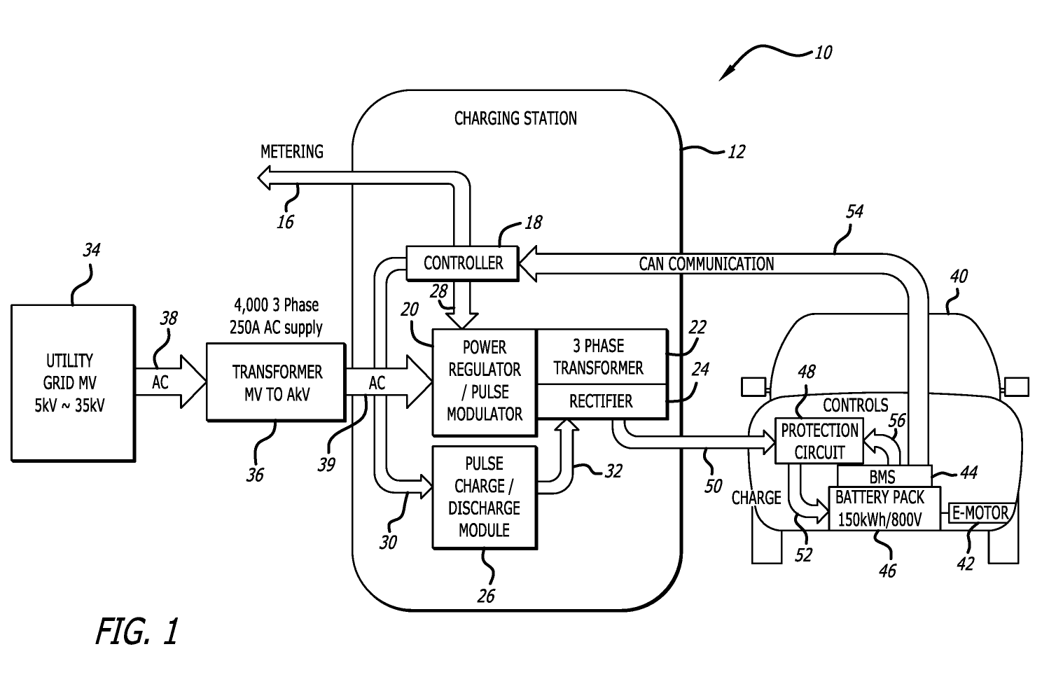

As shown in FIG. 1 for purposes of illustration, an embodiment of the present invention resides in a charging station system 10. The system 10 includes a charging station 12. The charging station 12 is configured to charge EV and hybrid vehicles (e.g., plug-in hybrid vehicles) capable of high power charging and pulse charging, as well as other automotive electric vehicles configured to receive DC fast charge under the Society of Automotive Engineers (SAE) Combo Connector (sometimes referred to as Combined Charging System (CCS)) charging standard (also referred to as SAE CCS), the CHAdeMO standard, and other applicable charging standards.

The charging station 12 includes a central processing unit (CPU) or controller 18 configured to control the operational functions of the charging station system 10. The controller 18 is configured for metering 16. Metering 16 is power measurement that may be used for billing, especially if the MV electrical grid does not include meters. The controller 18 is also configured to manage charging current and voltage. The charging station 12 further includes power electronics that include a power regulator/pulse modulator 20, a three-phase transformer 22, a rectifier 24, and a pulse charge/discharge module 26. The power regulator/pulse modulator 20 functions as a voltage and current regulator (e.g., the power regulator/pulse modulator 20 regulates the MV grid voltage down to 1-4 kV) and regulates current of three phase AC power that flows to the three phase transformer 22. The power regulator/pulse modulator 20 adjusts the amount of power that will go to the batteries/battery pack of the electric vehicle and executes pulse charging of the electric vehicle, as instructed by the controller 18. The three-phase transformer 22 is where the AC power is transformed to lower voltage and higher current, which is then rectified to DC power by the rectifier 24. The three-phase transformer 22 further adjusts the voltage to a desired level, as directed by the controller 18 (e.g., 400V or 800V depending on the battery voltage of the vehicle 40 being charged).

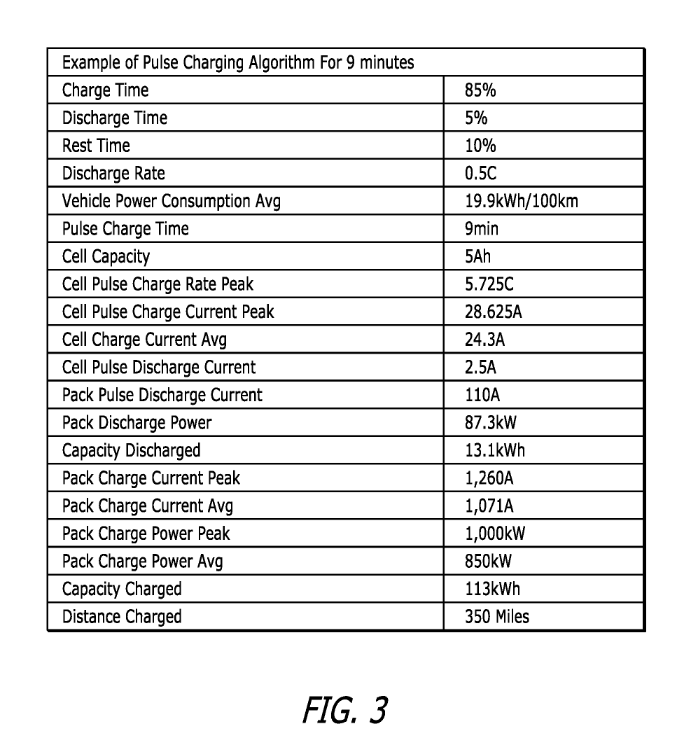

The rectifier 24 is configured to rectify the voltage to the proper threshold to safely charge the vehicle 40. The pulse charge/discharge module 26 is configured to emit pulsed current signals (e.g., as per the pulse charge algorithm of FIG. 3).

The controller 18 is in operational communication 28 with the power regulator/pulse modulator 20, and is also in operational communication 30 with the pulse charge/discharge module 26, and controls the charging of the electric vehicle. For a discharge phase of the pulse charge algorithm of FIG. 3, the energy storage module 144 or load can be used. The energy storage module 144 will be more efficient overall. When a battery pack 46 is being charged, then either the power supply or another battery (e.g., the energy storage module 144 can include a battery with power electronics allowing either release or absorption of energy) provides energy. When the battery pack 46 is being discharged, then load is being applied to the battery pack 46. The pulse charge/discharge module 26 is in operational communication 32 with the rectifier 24. The term “operational communication” may refer to a wired connection, a wireless connection (e.g., Bluetooth™, ZigBee™, Wi-Fi, Wi-SUN, infrared, near field communication, ultraband, or some other short-range wireless communications technology), or a combination thereof. The charging station system 10 may include a communication module (not shown) providing wireless connections between various portions of the charging station system 10, including communication between the charging station 12 and any vehicles 40 being charged.

The charging station system 10 also includes a connection to Utility Grid MV (e.g., 5 kV˜35 kV) 34, and a transformer 36. AC 38 flows from the Utility Grid MV 34 to the transformer 36. The transformer 36 transforms MV to AkV [Martin: What does “AkV” stand for?] and serves as a 4000 Three Phase 250 A AC supply. The AC 39 leaving the transformer 36 then flows to the charging station 12 and, in particular, the power regulator pulse modulator 20. The charging station 12 is configured to charge one or more vehicles 40 (each vehicle 40 having at least one battery) that require periodic re-charging (e.g., an EV or hybrid vehicle). The vehicle 40 receiving the charge from the charging station 12 has an electric powertrain capable of operating at a nominal voltage of 800V and an on-board battery capable of accepting charge at such nominal voltage. Each vehicle 40 has vehicle-specific information relating to the make/model of that vehicle 40 (e.g., charge capacity, etc.). The vehicle 40 also includes a battery interface (e.g., an electro-mechanical receptacle) that can create a direct connection to a mating interface of the charging station 12 (e.g., a coupling mechanism (not shown)) that can deliver 1,000 A continuous current or a pulse current to the battery pack 46 for charging without needing additional cooling other than the battery cooling system existing on-board the EV 40. The coupling mechanism for charging the vehicle 40 can include charging cables that having connectors that include, but are not limited to, Level 3 standard SAE CCS connectors, ChaDeMo connectors, and any Level 4 standard plug. The EV 40 includes at least one electric motor (or E-motor) 42, a battery management system (BMS) 44, a battery pack 46, and a protection circuit 48.

In connection with the operation of the vehicle 40, the BMS 44 performs various tasks including, but not limited to, monitoring of the voltage of the individual battery cells within the battery pack 46, and balancing the battery cells within the battery pack 46. The BMS 44 also monitors the state of charge of the battery pack 46, and performs a state of health calculation. The BMS 44 also monitors the temperature of the battery cells within the battery pack 46. The BMS 44 may include a computing device that can store information in a memory accessible by one or more processors, including instructions that can be executed by the one or more processors. The memory can also include data that can be retrieved, manipulated or stored by the processor. The memory can be of any non-transitory type capable of storing information accessible by the one or more processors, such as a solid state hard drive (SSD), disk based hard-drive, memory card, ROM, RAM, DVD, CD-ROM, Blu-Ray, write-capable, and read-only memories. The instructions can be any set of instructions to be executed directly, such as machine code, or indirectly, such as scripts, by the one or more processors. In that regard, the terms “instructions,” “application,” “steps,” and “programs” can be used interchangeably herein. The instructions can be stored in a proprietary or non-proprietary language, object code format for direct processing by a processor, or in any other computing device language including scripts or collections of independent source code modules that are interpreted on demand or compiled in advance. Data may be retrieved, stored or modified by the one or more processors in accordance with the instructions. For instance, although the subject matter described herein is not limited by any particular data structure, the data can be stored in computer registers, in a relational or non-relational database as a table having many different fields and records, or XML documents. Moreover, the data can comprise any information sufficient to identify the relevant information, such as numbers, descriptive text, proprietary codes, pointers, references to data stored in other memories such as at other network locations, or information that is used by a function to calculate the relevant data. The controller 18 is in operational communication with the BMS 44 such that data including, but not limited to, the state of charge of the battery pack 46, temperature of the battery pack 46, and the like is shared with the controller 18.

The protection circuit 48 receives electrical power (e.g., 1000V/1000 A DC) 50 from the rectifier 24. The electrical power 50 passes through the protection circuit 48 and then provides charge 52 to the battery pack (e.g., 150 kWh/800V) 46. The protection circuit 48 detects any high voltage leaks (i.e., high voltage can not leak into chassis ground or ground of the charging station 12), detects any over—under voltages, over and under temperatures, and other conditions. The protection circuit 48 works with the BMS 44. Depending on the make/model of EV, the protection circuit 48 may sometimes be a part of the BMS 44 and sometimes the protection circuit 48 is separate from the BMS 44. The BMS 44 is in operational communication 54 with the power regulator pulse modulator 20, and provides Controller Area Network (CAN) communication with the controller 18. CAN is a communication standard used in motor vehicles. CAN can be used to communicate with the charging station system 10 but, in the alternative, other standards may be used including wireless communication of any kind. The communication line 54 orders the charging station 12 to deliver a certain amount of power that the BMS 44 will allow to charge the batteries of the battery pack 46 with, and shares other information (e.g., temperature, current, voltage, state of charge, state of health of the battery, overheating, overcharging, charge is complete/incomplete, start and end of charge, etc.). The operational communication 54 between the BMS 44 and the power regulator pulse modulator 20 may be wired or wireless (e.g., a wireless connection may be provided by a communication module (not shown)). The BMS 44 is also in operational communication 56 with the protection circuit 48, and communicates information (e.g., temperature, current, voltage, state of charge, state of health of the battery, overheating, overcharging, charge is complete/incomplete, start and end of charge, etc.).

The charging station system 10, described above, provides connection an MV grid 34, a power electronic system for up to 1 MW; high power-factor, low harmonic distortion; and alternating current to direct current (AC-DC) conversion to charge batteries with 800 V and/or 400 V nominal DC voltages in programmable constant current and pulse-current modes.

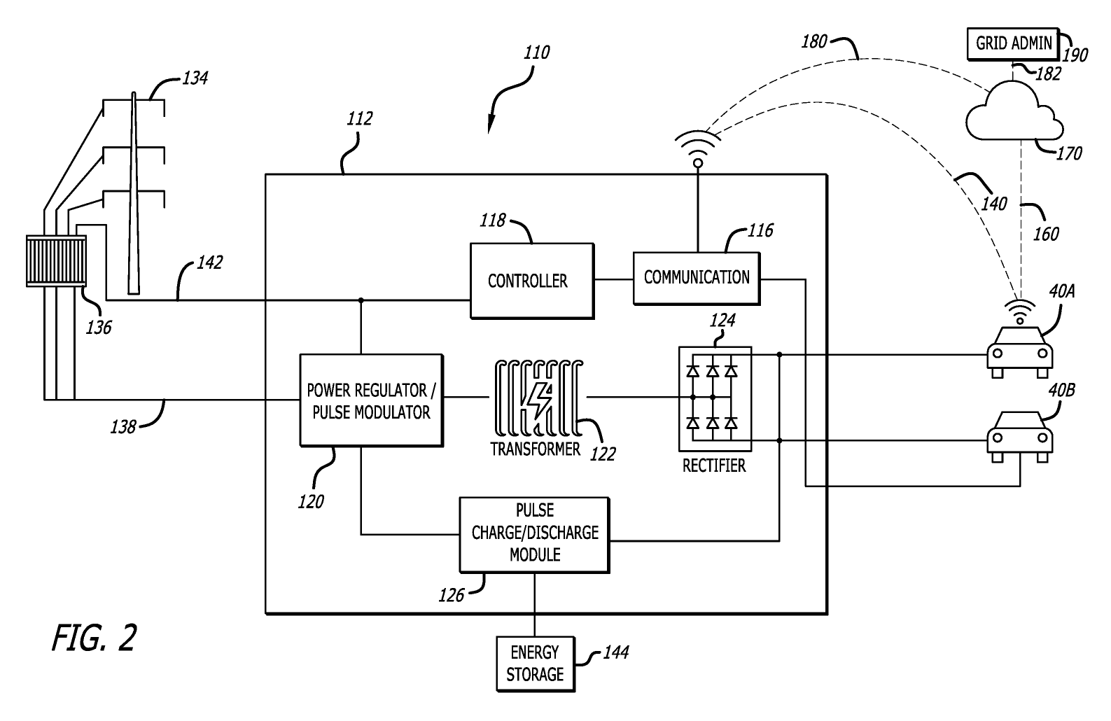

As shown in FIG. 2 for purposes of illustration, another embodiment of the present invention resides in a charging station system 110. The system charging station 110 is similar to the charging station system 10, described above, with the functions of various components of each charging station system 10, 110 being similar (if not identical) to the functions of corresponding components in the other charging station system 110, 10. The charging station system 110 includes a charging station 112. The charging station 112 includes a communication module 116, and a controller 118 configured to control the operational functions of the charging station system 110. The controller 118 is used to manage charging current and voltage as directed by communications coming through the communication module 116, and provides feedback through the communication module 116, if not in direct communication with other components of the charging station system 110. The communication module 116 translates data from the electric vehicle and orders the controller 118 to operate the power electronics per vehicle demand (e.g., per the vehicle-specific information relating to the particular make/model of the vehicle 40 being charged). Communication between the controller 118 and the communication module 116 may include, but are not limited to, voltage, current, temperature, and the like. The controller 118 receives vehicle-specific information (e.g., charging/discharging parameters) through the communication module 116. The communications module 116, over a wireless link connection (e.g., Bluetooth™, ZigBee™, Wi-Fi, Wi-SUN, infrared, near field communication, ultraband, or some other short-range wireless communications technology), communicates with a vehicle 40 (and the BMS 44 of the vehicle 40) in proximity to the charging station 12. The charging station system 110 may include two ranges of wireless communication: short range, and long range. The short or close proximity range (e.g., Wi-Fi, Bluetooth or other short range) provides wireless communication anywhere from one (1) to five hundred (500) feet of the charging station 112, and preferably within approximately 100 feet of the charging station 112. The long range wireless communication can be provided by wireless technologies that include, but are not limited to, cellular, GPRS, 4G, 5G, LTE, or the like. Specific examples of vehicle-specific information transmitted from the vehicle 40 to the controller 118 include, but are not limited to, battery voltage, state of charge, battery internal resistance, battery temperature, power demand, battery state of health, amount of charge required, charging current, VIN number, error codes if any, software version, charging algorithm (e.g., CC/CV, pulse charge, etc.), driving habits, planned driving distance and the like.

The charging station 112 further includes a power regulator/pulse modulator 120, a three-phase transformer 122, a rectifier 124, and a pulse charge/discharge module 126. The power regulator/pulse modulator 120 functions as a voltage regulator (e.g., the power regulator/pulse modulator 120 regulates the MV grid voltage down to 1-4 kV) and regulates current of three phase AC power that flows to the three phase transformer 122. The power regulator/pulse modulator 120 regulates power (current) at high voltage on a primary side of the coil of the transformer 122. For example, 1 MW will be 250 A and 4000V—to regulate 250 A is much easier; generating less heat, allowing for use of smaller elements, and providing more efficiency than 1000 A and 1000V which is 1 MW, too.

The three-phase transformer 122 is where the AC power is transformed to lower voltage and higher current, and then rectified to DC power in a rectifier 124 (e.g., a Vienna rectifier). The station 112 is configured to charge EV and hybrid vehicles (e.g., plug-in hybrid vehicles) capable of high power charging and pulse charging, and other automotive electric vehicles configured to receive DC fast charge under the SAE CCS standard, the CHAdeMO standard, and other applicable charging standards. The three-phase transformer 122 further adjusts the voltage to a desired level dictated by the controller 118 (e.g., 400V or 800V depending on the battery voltage of vehicle 40A, 40B being charged).

The rectifier 124 is used to rectify the voltage to the proper threshold to safely charge the vehicle 40A, 40B. The pulse charge/discharge module 126 is configured to emit pulsed current signals (e.g., as per the pulse charge algorithm of FIG. 3).

The controller 118 is in operational communication with the power regulator/pulse modulator 120, and is also in operational communication with the pulse charge/discharge module 126. In addition to running pulse charge algorithm of FIG. 3, the controller 118 can run constant current charging, terminate charging, and generally control the process of charging the electric vehicle. Different electric vehicles (e.g., different makes/models of electric vehicle) may have different algorithms for charging (i.e., charging algorithms based on the unique characteristics of a particular make/model of electric vehicle). The controller 118 has that data and can be updated wirelessly at any time. The controller 118 can also communicate all charging information from every charging session (including but not limited to, vehicle information like VIN, mileage, state of charge, etc.). The pulse charge/discharge module 126 is in operational communication with the rectifier 124. The term “operational communication” may refer to a wired connection, a wireless connection, or a combination thereof. The wireless connection may be provided by the communication module 116.

As with the system 10, the system 110 also includes a connection to a Utility Grid MV (e.g., 5 kV˜35 kV (preferably 32.5 kV) 134, and a transformer 136 connected to the grid 134. AC flows from the Utility Grid MV 134 to the transformer 136. The transformer 136 transforms MV to AkV and serves as a 4000 Three Phase 250 A AC supply. Power regulation is on a primary side of the transformer 136 with power electronics. A signal 142 runs from the transformer 136 to the primary side of the transformer power electronics. The signal 142 regulates power. The signal 142 is a message that goes to power regulation elements based on Silicon Carbide (SiC) or other compound and works similar to a digital potentiometer (e.g., it regulates current flow and/or voltage and/or causes pulse. The AC 138 (e.g., 1-4 kV) leaving the transformer 136 then flows to the charging station 112 and, in particular, the power regulator/pulse modulator 120.

The transformer 122 may be optional as long as the transformer 136 can convert the MV grid power to a voltage acceptable by the rectifier 124. The charging station 112 can be dual voltage from one transformer with dual windings or two transformers can be used or a combination thereof. In an example, if the transformer 136 includes a single-winding, and the rectified voltage will be 800V, then another transformer will be required to provide 400V. If the transformer 136 includes a dual-winding, the transformer 136 will provide both voltages from a single assembly. Depending on battery type, only one transformer with 1000V can charge a variety of batteries with different nominal voltages. The rectifier 124 can be a Vienna-type rectifier (which allows some power regulation) or a regular rectifier.

The charging station 112 is configured to charge one or more vehicles 40A, 40B (each vehicle 40A, 40B having at least one battery) that requires periodic re-charging (e.g., an EV or hybrid vehicle). The vehicles 40A, 40B have similar/identical internal components as described above in connection with the vehicle 40 of FIG. 1. The vehicle 40A represents a 800V powertrain EV, and the vehicle B represents a 400V powertrain EV. The vehicle 40A represents an “Ultra Charger” scenario where the protection circuit 48 of the vehicle 40A receives electrical power (e.g., 250V-1000V DC/50 A-1000 A) from the rectifier 124. The vehicle 40B represents an “L3/L4” scenario where the protection circuit 48 of the vehicle 40B receives electrical power (e.g., 250V-450V DC/50 A-800 A) from the rectifier 124. The electrical power passes through the protection circuit 48 and then provides charge to the one or more batteries (e.g., in a battery pack). As discussed above, the protection circuit 48 works with the BMS 44. The operational communication between the BMS 44 and the power regulator/pulse modulator 120 may be wired or wireless (e.g., a wireless connection may be provided by a communication module 116). For example, the vehicle 40A is illustrated as being in direct wireless communication 140 with the communication module 116 of the charging station 112 or, alternatively, as being in indirect wireless communication with the communication module 116 of the charging station 112. Indirect wireless communication from the vehicle 40A to the communication module 116 of the charging station 112 involves the vehicle 40A being in wireless communication 160 with a Network 170, which then wireless communicates 180 with the communication module 116. Either way, the communication module 116 then communicates with the controller 118 which, in turn, then communicates with the power regulator/pulse modulator 120. Wireless communication 160, 180 between vehicle 40A and the charging station 112 (via Network 170) allows the charging station 112 to prepare or reserve charging time for the vehicle 40A. Preparation includes power demand, communication with a grid administrator 190 (via Network 170) and preparation of grid energy storage or an energy storage module 144 (if installed; the energy storage module 144 being optional). The energy storage module 144 is connected to the pulse charge/discharge module 126. The grid administrator 190 (e.g., a power company, or whoever controls the local power grid) can direct power into different areas. When the charging station 112 puts a load on the power grid, the grid administrator 190 can stabilize the power grid by engaging another energy storage close by. The energy storage module 144 can release energy back to the power grid upon grid administrator demand and when certain conditions are met (e.g., conditions including, but not limited to, state of charge, state of energy storage, temperature, number of faults, etc.). During discharge mode of the pulse charging, the energy storage module 144 absorbs discharge from a vehicle's battery or battery pack. When the electric vehicle battery pack is in discharge mode of the pulse charging algorithm, the energy storage module 144 is being charged and absorbs energy from the vehicle battery pack 46. Alternatively, load can be used as power resistor or other. Also, when the vehicle 40A approaches the charging station 112, the grid administrator 190 can prepare for the anticipated load on the power grid. The charging station 112 is in operational communication with the grid administrator 190 through the Network 170, which is in operational communication 182 with the grid administrator 190.

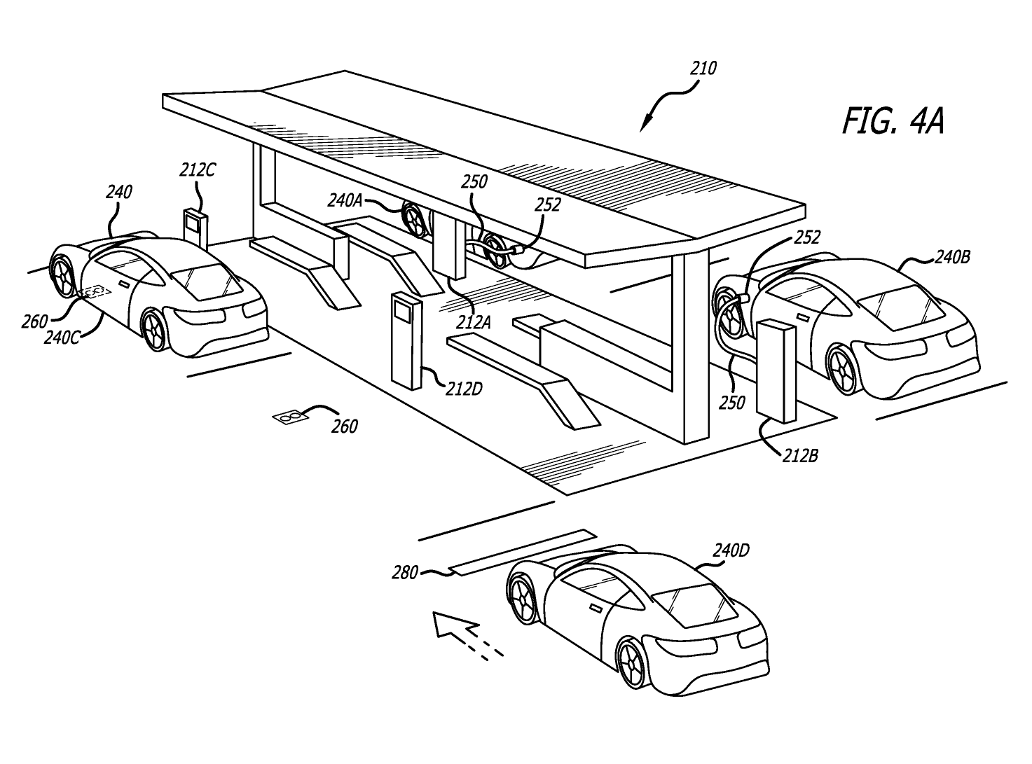

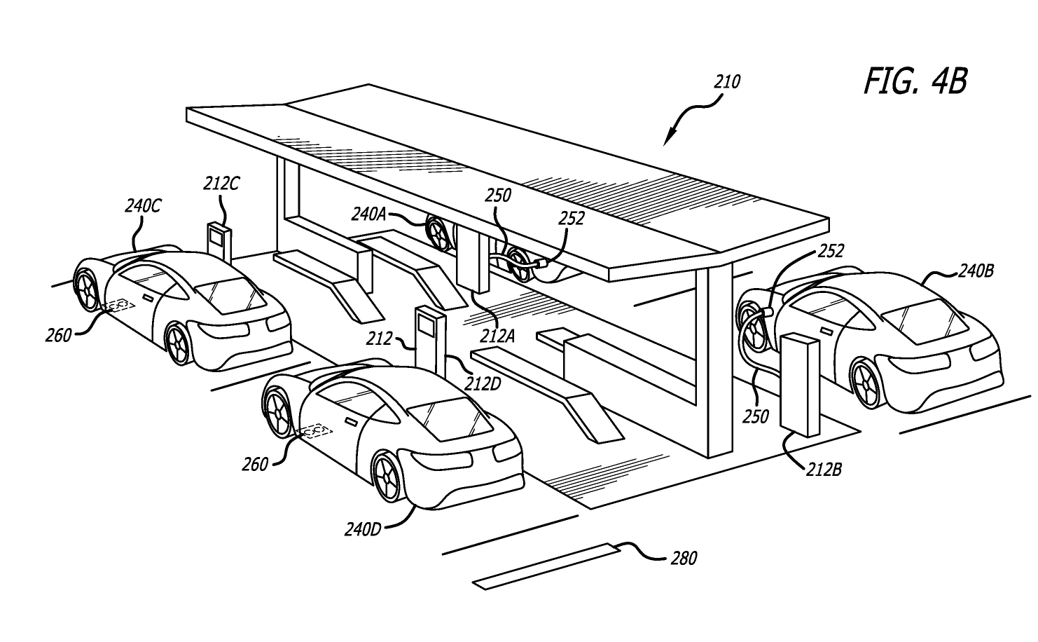

As discussed above, the charging station 12, 112 includes a direct connection to the MV grid 34, 134, and additional energy storage 144 for grid stabilization or to leverage local renewable energy generation or both. The charging station 12, 112 may work as a bi-directional grid power regulator where energy is stored from the MV grid 34, 134 at low demand hours and energy is pushed back into the MV grid 34, 134 during peak demand hours. In addition, the local energy storage 144 may be used to support charging peak demands. For example, in the charging station system 210 of FIGS. 4A and 4B, in the event where four (4) vehicles 240A-D have a need for fast charging at power level above 350 W each, then the local energy storage 144 can be used by the charging station system 10, 110, 210 to offset some of the power demands. The energy storage module 144 will release power and charge batteries of the battery pack 46 using energy stored in storage or will assist the electric grid 134 by putting less load on the electric grid 134. The energy storage module 144 will then be slowly recharged when there is low power demand or energy price from the grid administrator 190.

The charging station 12, 112 provides only DC charging but is able to provide vehicles with charging options (e.g., CC/CV, pulse charging, or a combination thereof). Any cable and connecting standard can be used for charging (e.g., SAE COMBO, CHAdeMO; an in-ground connector able to be engaged to/disengaged from the vehicle 40 either autonomously or manually; or the like). For example, an in-ground connector 260, such as an in-ground conductive charging coupler or charge connector, can be used to deliver power from the electric grid to the vehicle/battery with an auto-park feature to position an EV 40 over the charging coupler without a user having to exit the vehicle. The auto-park feature may involve the charging station system 10, 110 taking direct control over the vehicle 40 or providing instructions to the vehicle's own autonomous driving system for parking the vehicle 40 in position over the in-ground connector. Alternatively, the auto-park feature may involve the charging station system 10, 110 taking direct control over the vehicle 40 or providing instructions to the vehicle's own autonomous driving system for parking the vehicle 40 in position near an appropriate charging coupler that requires manual engagement to/disengagement from the vehicle 40. In one particular embodiment, the in-ground conductive coupler 260 can plug into a bottom of the EV. This charging coupler may have more than two terminals as there may be ground-coupling required, or combination of a high-power charge coupler and regular J1772 plug or other standard for communication and ground may be used. Wired and/or wireless communication between the charging station 12, 112 and the vehicle 40 allows a user to be select an up to MV grid connection node (e.g., 5 kV˜35 kV), and a power electronic system for up to 1 MW, high power-factor, low harmonic distortion, AC-DC conversion to charge a battery with 800 V and/or 400 V nominal DC voltages in programmable CC/CV and/or pulse charging modes.

As seen in FIGS. 1 and 2, the charging stations 12, 112 may represent only a single charging station or multiple charging stations at the same location operating within the overall charging station system 10, 110. If there are multiple charging stations 12, 112 at a single location, some of the components (e.g., power regulator/pulse modulator 20, 120; pulse charge/discharge module 26, 126; transformer 22, 122; etc.) seen in the charging stations 12, 112, of FIGS. 1 and 2 may be found within each charging station 12, 112 while other components (e.g., controller 18, 118; communication module 116 (not shown in FIG. 1); etc.) may be physically separate from each charging station 12, 112 but in communication (e.g., wired; wireless; etc.) therewith.

With regard to FIGS. 1 and 2, the controller 18, 118 is configured for wired and/or wireless communication with the vehicles 40 being charged. The communication is used to carry out various functions including, without limitation, communicating with a particular vehicle 40 coming into communications range with the charging system 10, 110; determining the charging standard appropriate for the particular vehicle 40; confirming the charging standard appropriate for the particular vehicle 40; providing a user (e.g., driver of the vehicle 40, or alternatively, the on-board autonomous driving system of the vehicle 40) with a choice of charging modes (e.g., CC/CV mode; a pulse charging mode; etc.); confirming the charging mode selected by the user; warning the user if the charging mode selected by the user is not appropriate or recommended for that vehicle 40; providing instructions/data to the vehicle 40 for autonomously parking the vehicle 40 by a particular charging station 12, 112 that is available and/or suitable for charging the particular vehicle 40; providing information to the driver of the vehicle 40 regarding which charging station 12, 112 is available/appropriate for the particular vehicle 40 if the driver desires to manually park the vehicle 40; engaging the vehicle 40 to a coupling mechanism (e.g., a charging cable, an in-ground coupler 260 configured to engage an underside of the vehicle 40, etc.) used to electrically connect the vehicle's batteries or battery pack to the charging station 12, 112 (if the coupling mechanism does not require manual connection to the vehicle 40 by the user); receiving vehicle-specific information from the vehicle 40; determining if a particular charging coupler appropriate to the vehicle 40 has made proper electrical connection with the vehicle 40 in order to safely energize the appropriate charging coupler at start of charge; charging the vehicle 40 using the charging mode selected by the user; monitoring the charging during the charging process; determining the end of charge; safely terminating charging; and disengaging the coupling mechanism from the vehicle 40 (if the coupling mechanism does not require manual disconnection from the vehicle 40 by the user). As seen in FIGS. 4A and 4B, more than one vehicle 40 may be re-charging at any particular time, and the controller 18, 118 is able to carry out concurrent charging of multiple vehicles 40. The controller 18, 118 may include a computing device that can store information in a memory accessible by one or more processors, including instructions that can be executed by the one or more processors. The memory can also include data that can be retrieved, manipulated or stored by the one or more processors. The memory can be of any non-transitory type capable of storing information accessible by the one or more processors, such as a solid state hard drive (SSD), disk based hard-drive, memory card, ROM, RAM, DVD, CD-ROM, Blu-Ray, write-capable, and read-only memories. The instructions can be any set of instructions to be executed directly, such as machine code, or indirectly, such as scripts, by the one or more processors. In that regard, the terms “instructions,” “application,” “steps,” and “programs” can be used interchangeably herein. The instructions can be stored in a proprietary or non-proprietary language, object code format for direct processing by a processor, or in any other computing device language including scripts or collections of independent source code modules that are interpreted on demand or compiled in advance. Data may be retrieved, stored or modified by the one or more processors in accordance with the instructions. For instance, although the subject matter described herein is not limited by any particular data structure, the data can be stored in computer registers, in a relational or non-relational database as a table having many different fields and records, or XML documents. Moreover, the data can comprise any information sufficient to identify the relevant information, such as numbers, descriptive text, proprietary codes, pointers, references to data stored in other memories such as at other network locations, or information that is used by a function to calculate the relevant data. The charging station 12, 112 may include a user interface (e.g., a graphical user interface) allowing a user to manually set charging of the electric vehicle 40 (e.g., identifying the make/model of vehicle to be charged; selecting a charging mode (e.g., CC/CV, pulse charging, etc.); providing a method of payment (e.g., cash; credit card; debit card; cryptocurrency; “gas card”; etc.); and otherwise inputting information relevant to the charging which may be prompted by the charging station 12, 112 as per instructions programmed into the controller 18, 118. Individual users (e.g., drivers, vehicle owners, or the like) and/or vehicles 40 may be registered with the charging station system 10, 110, 210, with information regarding the users, vehicles 40 and the like being stored in databases.

As seen in FIG. 3, an example of a pulse current charging (or pulse charging) algorithm is provided that is suitable for accelerated charging of Lithium ion batteries (e.g., Lithium batteries based on Nickel, Cobalt, Manganese Oxide cathodes). This pulse current charging algorithm is beneficial in allowing shorter recharge times and allowing higher recharge rates by diminishing the polarization component of the battery cells internal resistance and limiting the amount of heat generated during fast charge.

The pulse current charging algorithm is used by a charging station 12, 112 to provide much faster charging of an EV battery by utilization of the millisecond charging/discharging pulse charging algorithm instead of a CC/CV charging method. The pulse current charging algorithm provides greater C-rate charging without damaging or prematurely aging battery cells. The C-rate is a measure of the rate at which a battery is being discharged, and is defined as the discharge current divided by the theoretical current draw under which the battery would deliver its nominal rated capacity in one hour. For example, a 1 C discharge rate would deliver the rated capacity of a battery in one (1) hour, and a 2 C discharge rate means it will discharge twice as fast (i.e., in a half (0.5) hour). In theory, a 1 C discharge rate on a 1.6 Ah battery translates to a discharge current of 1.6 A, and a 2 C rate translates to a discharge current of 3.2 A. The pulse charging algorithm described herein allows depolarization of electrodes in the EV battery or battery pack; enabling reduced internal resistance because of removal of polarization component of the resistance. The pulse charging algorithm accelerates charging as the pulse charging algorithm defeats the charge polarization component of the internal resistance of the batteries/battery pack 46, and accelerates charging as the pulse charging algorithm reduces heat generation during charging. Depolarization causes less resistance, and less resistance translates into less heat and more energy that can be absorbed.

The illustrative pulse charging is based on a repeating pattern of a milliseconds high current charge, a pause for a period of time (e.g., milliseconds), a milliseconds discharge, a pause for a period of time, a milliseconds high current charge algorithm. In this manner, the pulse charging may be based on a repeating pattern of a high current charge for a plurality of milliseconds, a pause for a plurality of milliseconds, a discharge for a plurality of milliseconds, a pause for a plurality of milliseconds, and a high current charge for a plurality of milliseconds. Variables such as intervals frequency, time, pause, charge current, and discharge current are adjusted based on vehicle-specific information/parameters including, but not limited to, a vehicle-specific rate of charge to the electric vehicle battery, a vehicle-specific capacity of charge to the electric vehicle battery, a battery state of charge, battery temperature, power demand, and the like. As discussed above, the vehicle 40 is in operational communication with the charging station 12, 112 by wired and/or wireless connection. The operational communication between the vehicle 40 and the charging station 12, 112 allows the aforementioned vehicle-specific information/parameters of any particular vehicle 40 to be communicated from the vehicle 40 and factored into the charging of that particle vehicle 40. The charging station 12, 112 is able to monitor the charging of that particular vehicle 40. Communication can be in only one direction (i.e., from the vehicle 40 to the charging station) or, depending on the make/model of the particular vehicle 40, bi-directional (i.e., the charging station is also able to communicate information to the vehicle 40). The particular embodiment illustrated in FIG. 3 is but one example. All parameters of the pulse charging algorithm are adjustable depending on vehicle-specific information/parameters (such as those previously mentioned). In another illustrative example, the pulse charging algorithm is as follows: a thirty (30) milliseconds 5 C rate charge, a five (5) millisecond pause, a ten (10) millisecond 2 C rate discharge, a five (5) millisecond paus, and a thirty (30) millisecond 5 C rate charge. The charging pattern repeats until charging is complete.

As described above, there is flexibility to the algorithm. For example, the time of charge, the time of discharge, and/or the time of pause can be varied, individually or in combination. Also, alternating between charge, discharge and pause can also be varied, individually or in combination, as seen in the following examples: (1) charge, discharge, pause; (2) charge, pause, discharge; (3) discharge, charge, pause; and (4) discharge, pause, charge.

As seen in FIGS. 4A and 4B for purposes of illustration, another embodiment of the present invention resides in a charging station system 210 that can accommodate multiple electric vehicles 240 (e.g., four (e) electric vehicles 240A-D) being recharged at the same time. Each of the electric vehicles may be different makes and models of EVs from one another (and thus use different EV battery technologies, or use different charging couplers, and have different vehicle-specific information for charging the electric vehicle 40). The electric vehicle 240 may have similar/identical internal components as those described above in connection with the vehicle 40 of FIG. 1 such that the charging station system 210 is configured to operationally communicate with the electric vehicles 240A-D through a wired connection, wireless connection, or a combination of both wired/wireless connections. The charging station system 210 illustrates four (4) individual charging stations 212A-D (similar, if not identical, to the charging stations 12, 112) such that the four (4) electric vehicles 240A-D may be charged at the same time (one electric vehicle 240A-D per charging station 212A-D). Alternatively, each charging station 212A-D may be designed as a dual-charging station such that each charging station 212A-D is able to accommodate two (2) electric vehicles positioned on opposite sides of the dual-charging station. However, each charging station system 210 may be designed according to the needs of where the charging station system 210 is located such that the charging station system 210 may include only a single charging station or up to as many charging stations as the geographic size of the location upon which the charging station system 210 is situated will allow (similar to the manner in which a conventional gas station includes a number of individual gasoline pumps for handing a certain number of internal combustion vehicles filling-up with gasoline given the size of the gas station's location). While only EVs are illustrated as being charged in FIGS. 4A and 4B, plug-in hybrid vehicles (not shown) could also be charged at the charging station system 210.

For purposes of illustration, two of the vehicles 240A, 40B seen in FIGS. 4A and 4B are being charged at nominal voltage of 400V with a Level 3 charging power (e.g. 50 kW). Each vehicle 240A, 240B uses a different type of charge coupler and/or the charging coupler 250 connects to a different portion of the vehicle 240A, 240B as the vehicles 240A, 240B are different makes/models. In addition to the first two vehicles, an additional two vehicles 240C, 240D are shown being charged at 800V nominal voltage with a power level in excess of 350 kW. The total power level may not exceed 1 MW for the illustrated charging station system 210.

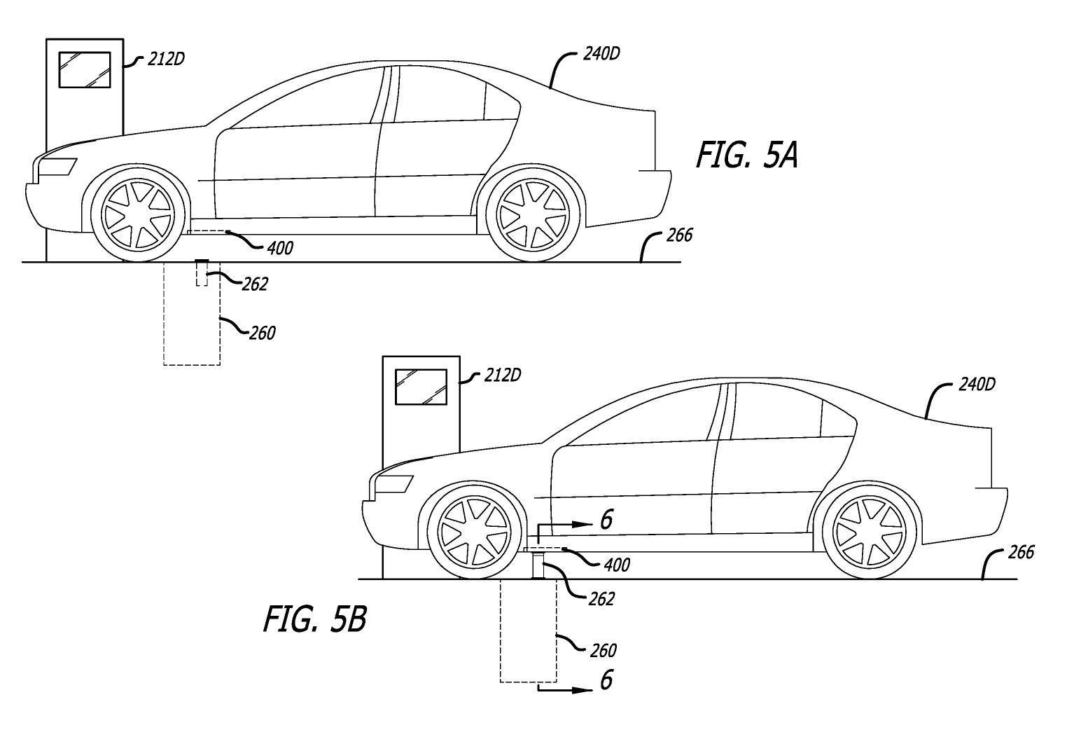

The EV 240C, 240D are each being charged by respective separate in-ground charging connectors or conductive couplers 260 in electro-mechanical communication with the charging station 212 to deliver electrical power from the electrical grid 34, 134 to the batteries/battery pack 46 of each EV 240C, 240D. An auto-park feature positions each EV 240C, 240D over its respective charging connector or coupler 260 without the driver of the EV having to exit the vehicle, as the in-ground coupler 260 automatically plugs into or otherwise electrically engages a charging receptacle or battery interface 400 on the bottom side of the EV 240C, 240D, as seen in FIGS. 5A and 5B. In the alternative, each EV 240C, 240D may be manually aligned with a respective coupler 260 by an on-board guidance system that includes a camera and display to show alignment of the vehicle's battery interface with the charging connector or coupler 260. The in-ground coupler 260 is configured such that a connecting portion of the in-ground coupler 260 moves upwards to plug into or otherwise electrically engage the battery interface 400 such that electrical charge may be transferred to the batteries/battery pack 46. The in-ground charging connector or coupler 260 is disposed underground, with a top of the in-ground coupler 260 generally planar with the ground surface 266. In one embodiment, the connecting portion of the in-ground coupler 260 moves upwards to electro-mechanically engage the vehicle 240C, 240D. The connecting portion includes two cylindrical charging posts 262, 264 configured such that each post 262, 264 is configured for linear actuation up and down (between generally stowed and generally deployed positions) for charging the EV 240C, 240D. Various linear actuators 296 can be used to vertically move the charging posts 262, 264 between up and down between stowed and deployed positions including, but not limited to, mechanical, electrical, electro-mechanical, hydraulic, pneumatic, or the like. Each of the charging posts 262, 264 is movable between generally stowed and generally deployed positions; one of the posts 262, 264 being an electrically positive pole (e.g., positive terminal), and the other of the posts 264, 262 being an electrically negative pole (e.g., negative terminal). Each of the posts 262, 264 is capable of individual actuation up and down (i.e., moving between generally stowed and generally deployed positions. In the generally stowed position, the posts 262, 264 are generally disposed within the housing 268. The posts 262, 264 are in a generally deployed position when the charging posts 262, 264 engage the battery interface 400 on the bottom side of the electric vehicle 240C, 240D. The posts 262, 264 may not be completely vertically deployed when the posts engage the battery interface 400 as the distance between the ground surface 266 and the battery interface 400 may vary due to various factors including, but not limited to, tire inflation, wheel size, or the like. Sensors (not shown) in operational communication with the charging station 212C, 212D can determine contact (e.g., mechanical, electrical (e.g., low resistance connection), and/or both) between the posts 262, 264 and the battery interface 400. The vehicle 240C, 240D is positioned to properly target the charging posts 262, 264 and engage in charging once a safe and low resistance connection is made between the vehicle 240C, 240D and the in-ground coupler 260. Alternatively, the coupler 260 includes a single cylindrical post capable of moving up and down through a linear actuator 296 and of positioning itself in full contact with the charging receptacle of the vehicle 240C, 240D.

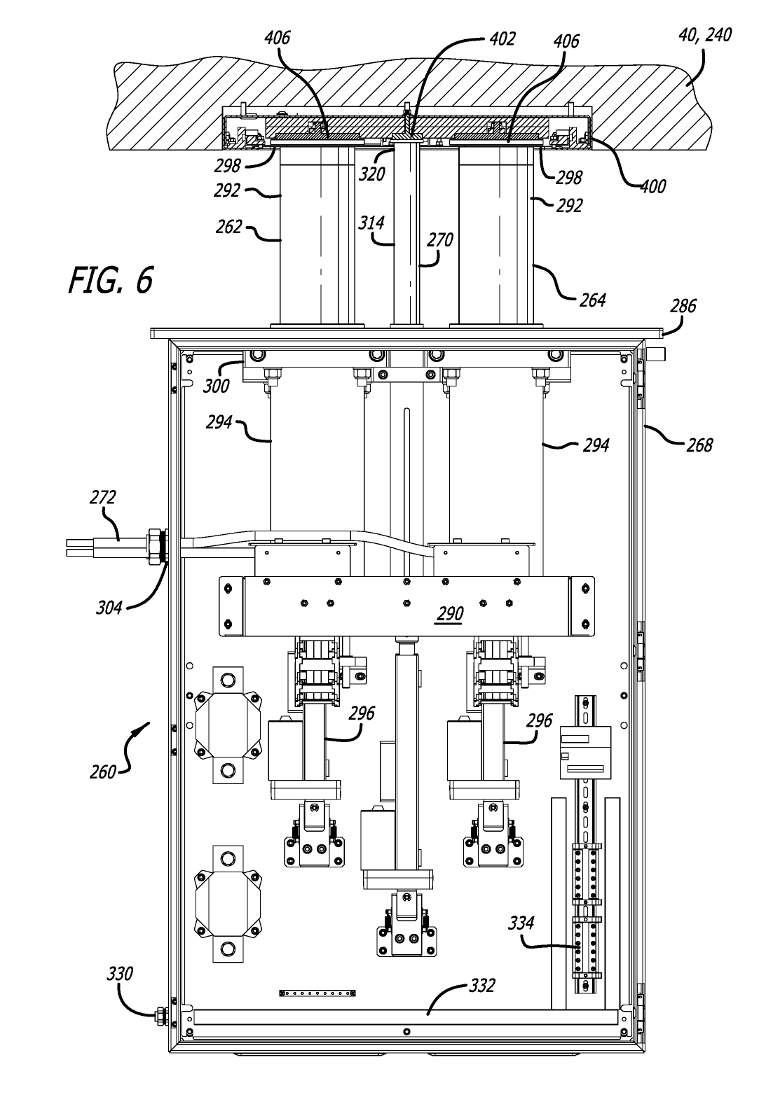

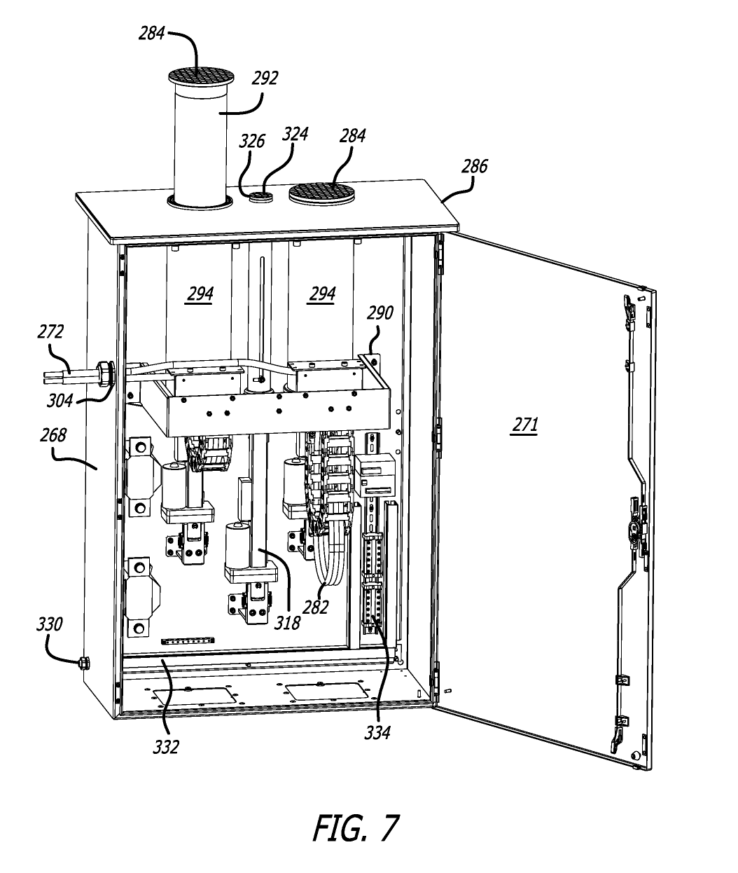

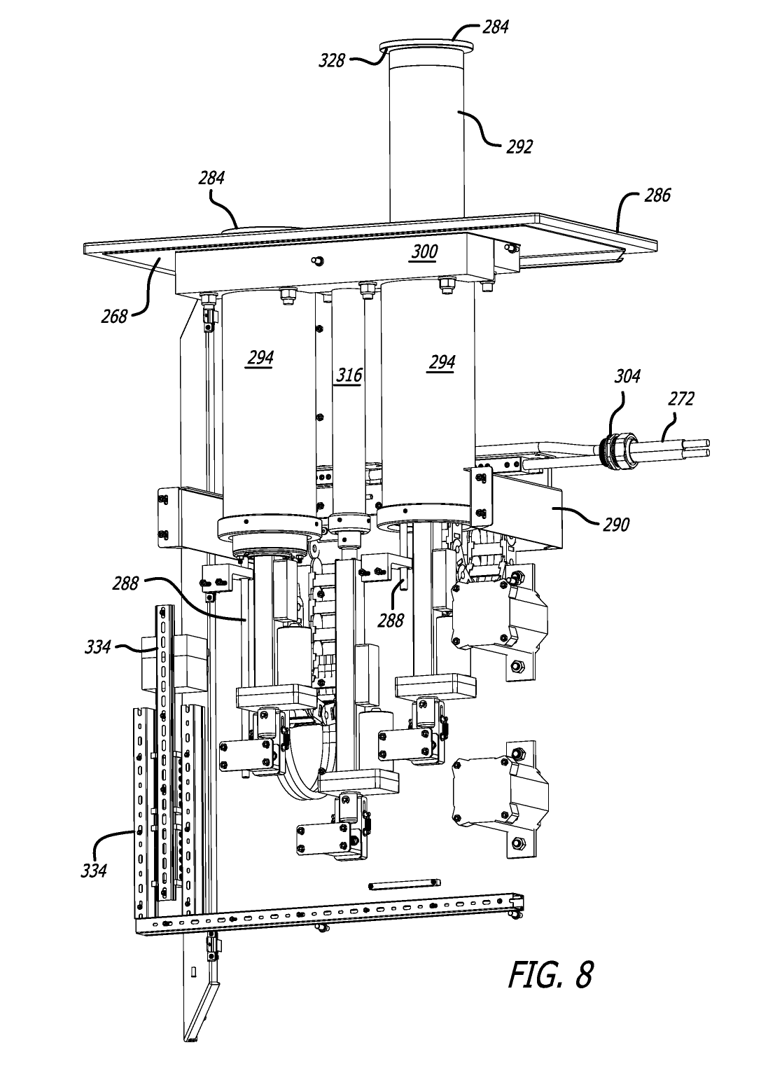

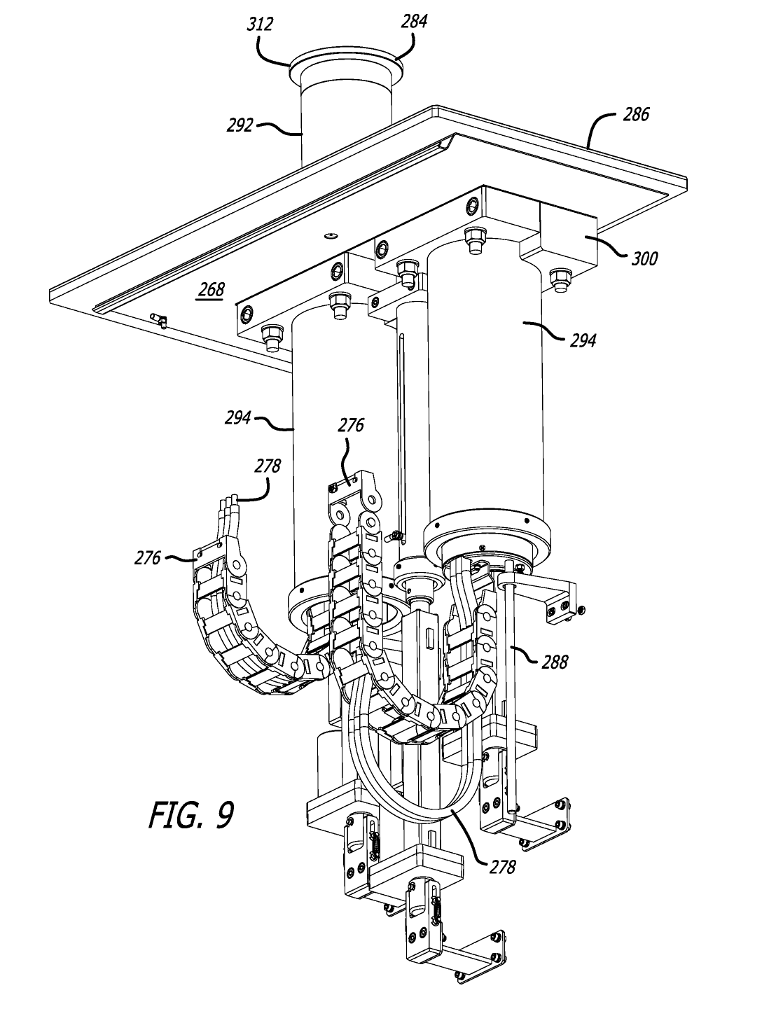

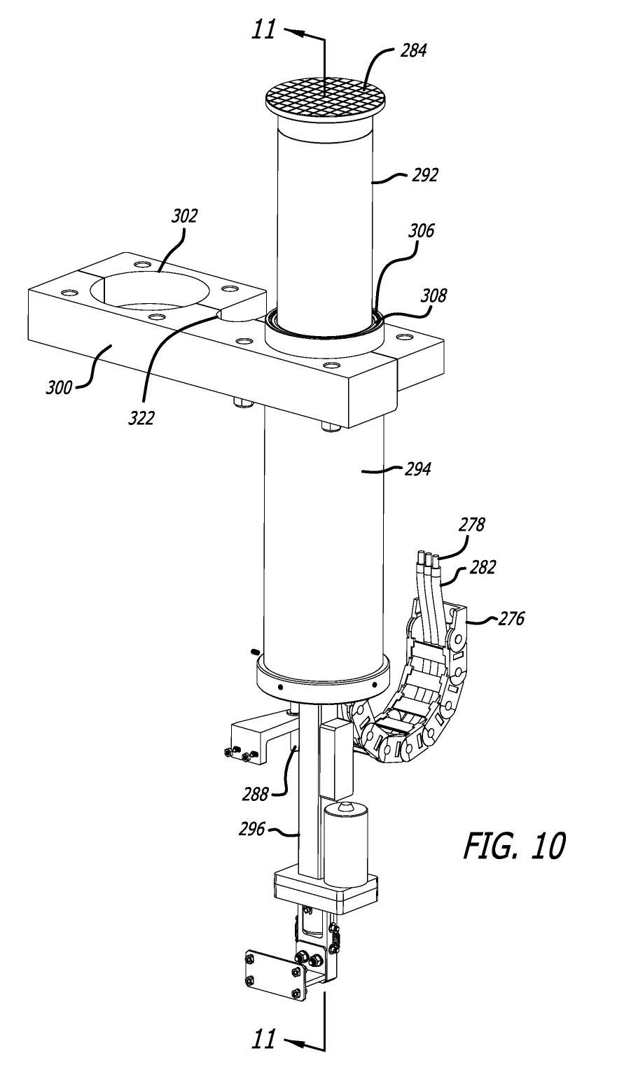

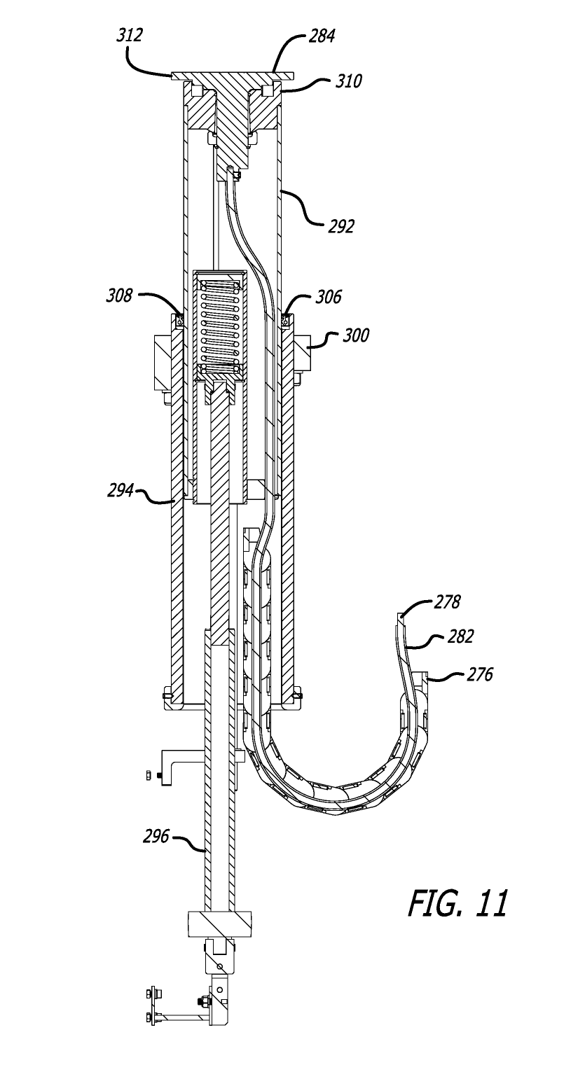

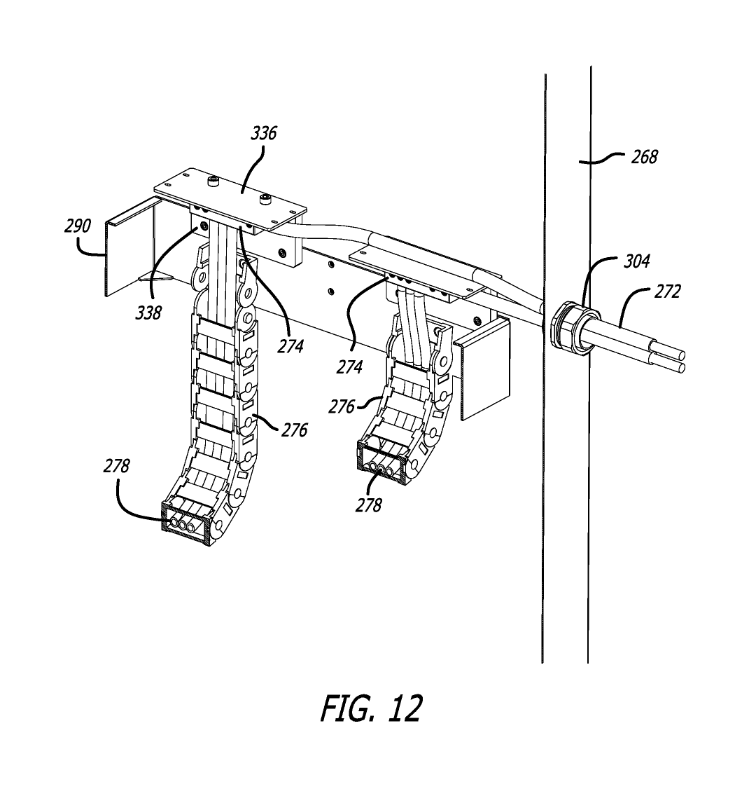

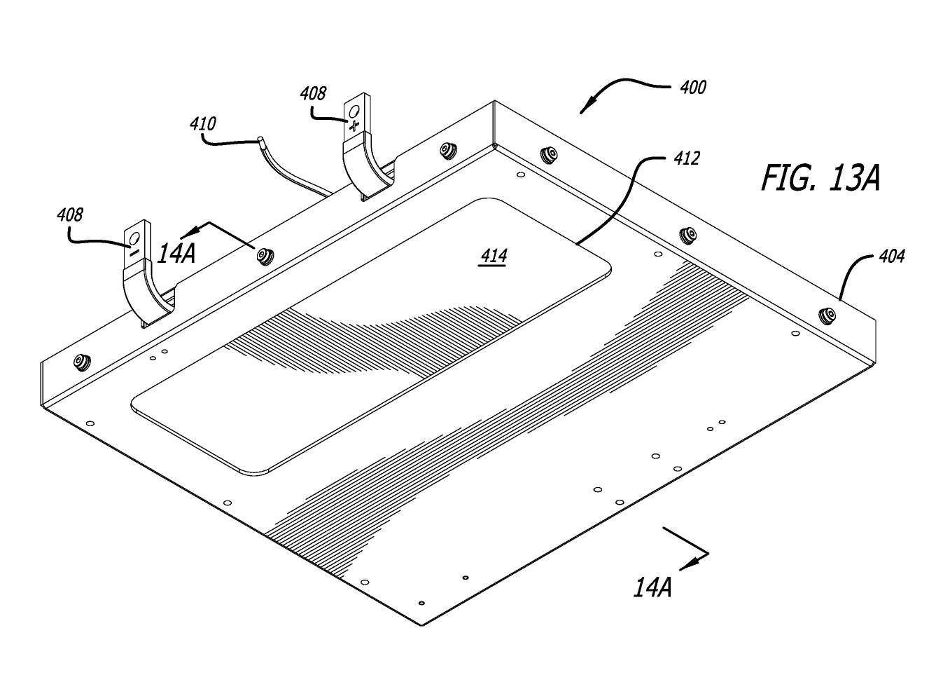

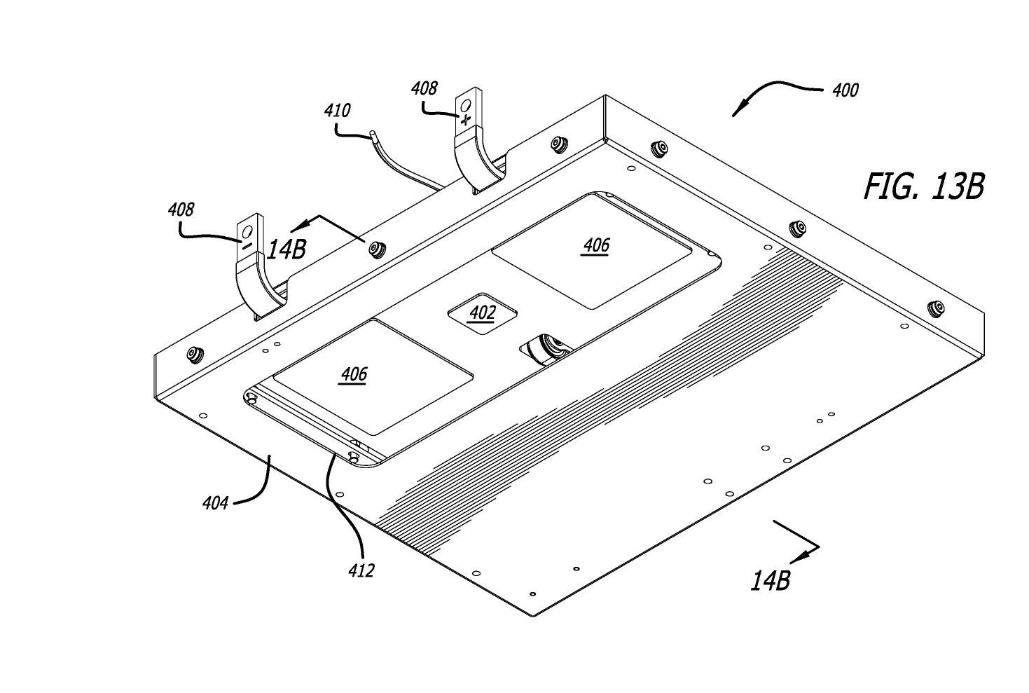

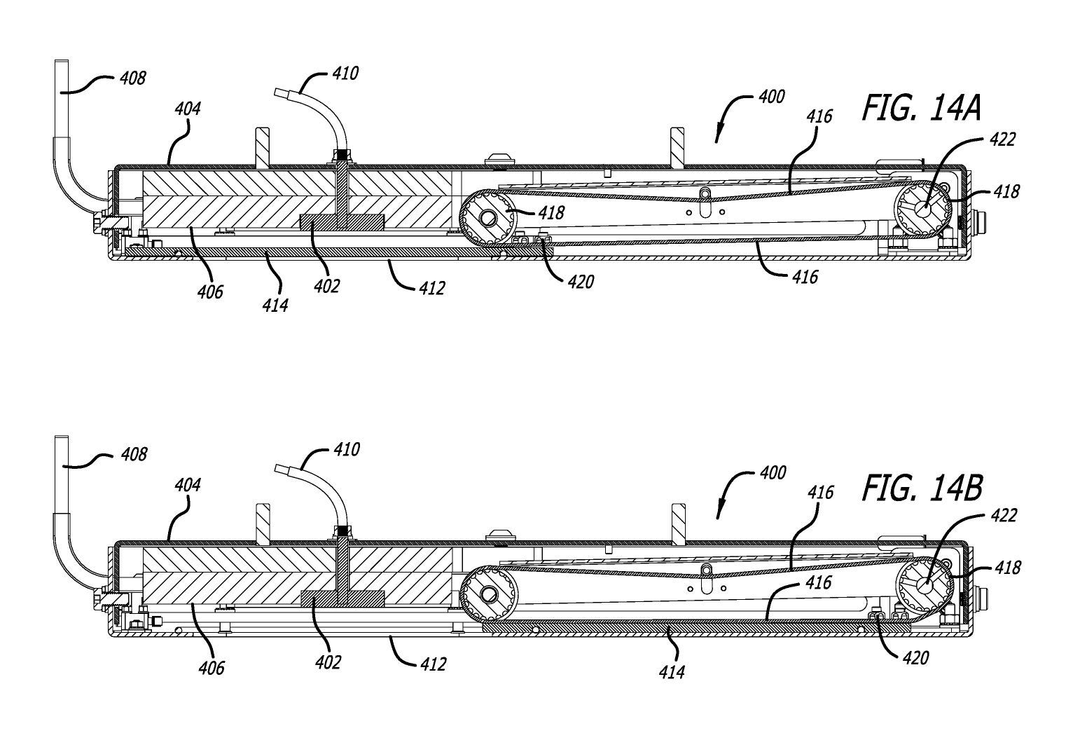

As seen in FIGS. 6-12, an embodiment of the in-ground coupler 260 is movable between generally stowed and generally deployed configurations. The coupler 260 includes a housing 268 having an access door 271, two cylindrical charging posts 262, 264 capable of individual actuation up and down (i.e., between stowed and deployed positions) for charging or servicing, and a grounding post 270 that is also capable of individual actuation up and down (i.e., between stowed and deployed positions). The access door 271 is hingedly attached to the housing 268 and provides a hermetic/liquid tight seal when closed. The access door 271 provides access to the interior of the ousing 268 for inspection and maintenance.

Each cylindrical charging post 262 includes an inner hollow cylinder 292, and an outer hollow cylinder 294. The inner hollow cylinder 292 slidably moves in and out of the outer hollow cylinder 294 such that the inner hollow cylinder 292 is generally disposed within the outer hollow cylinder 294 when the charging post 262, 264 is in the stowed position. Each charging post 262, 264 includes a linear actuator 296 (e.g., electric, mechanical, electro-mechanical, pneumatic, hydraulic, piezoelectric, or the like) for vertically moving the inner hollow cylinder 292 up and down, in and out of the outer hollow cylinder 294. One end of each linear actuator 296 is operationally attached to the housing 268 and stationary and the other end of each linear actuator 296 is operationally attached to the inner hollow cylinder 292. Each of the posts 262, 264 can be in the form of a cylinder capable of moving up and down through a linear mechanical actuator and of positioning itself in full contact with the vehicle charging receptacle (e.g., the battery interface 400). The housing 268 includes two (2) upper openings 298, one for each of the charging posts 262, 264, and a collar 300 having two (2) openings 302 aligned with the openings 298 of the housing. One end of each outer hollow cylinder 294 is operationally attached to the housing 268 and the other end of each outer hollow cylinder 294 is disposed within the opening 302 and secured to the collar 300. The upper end of the outer hollow cylinder 294 has an inner neck forming a circular recess 306 in which a seal 308 may be disposed to prevent contaminants from entering a space between an outer diameter of the inner hollow cylinder 292 and an inner diameter of the outer hollow cylinder 294.

The grounding post 270 includes an inner hollow cylinder 314, and an outer hollow cylinder 316. The inner hollow cylinder 314 slidably moves in and out of the outer hollow cylinder 316 such that the inner hollow cylinder 314 is generally disposed within the outer hollow cylinder 316 when the grounding post 270 is in the stowed position. The grounding post 270 includes a linear actuator 318 (e.g., electric, mechanical, electro-mechanical, pneumatic, hydraulic, piezoelectric, or the like) for vertically moving the inner hollow cylinder 314 up and down, in and out of the outer hollow cylinder 316. One end of each linear actuator 318 is operationally attached to the housing 268 and stationary and the other end of each linear actuator 318 is operationally attached to the inner hollow cylinder 314. The grounding post 270 is capable of being moved up and down by the linear actuator 318 and of positioning itself in full contact with a earth contact pad or ground terminal pad 402 of the vehicle charging receptacle (e.g., the battery interface 400). The housing 268 includes an upper opening 320 for the grounding post 270 and the collar 300 has an opening 322 aligned with the openings 320 of the housing 268. One end of the outer hollow cylinder 316 is operationally attached to the housing 268 and the other end of the outer hollow cylinder 316 is disposed within the opening 322 and secured to the collar 300. The upper end of the outer hollow cylinder 316 has an inner neck forming a circular recess in which a seal may be disposed to prevent contaminants from entering a space between an outer diameter of the inner hollow cylinder 314 and an inner diameter of the outer hollow cylinder 318. The grounding post 270 grounded to the charging station's ground. Alternatively, grounding and communication with the vehicle 40, 240 can be achieved as well through a standard charging plug (e.g., SAE J1772, CHadeMO, or the like) engaging a receptacle on the vehicle 40, 240 for grounding and communication. In that case, only two (2) posts 262, 264 (e.g., positive and negative terminals) will be required in-ground to deliver power to the electric vehicle 40, 240, and a ground line with a communication line will go through the charging cable and plug connected to the vehicle 40, 240.

Each of the posts 262, 264 can include an anti-rotation rod 288 engaging the housing 268 to prevent each of the posts 262, 264 from rotating around its own longitudinal axis. Upper and lower proximity switches (not shown) are associated with each of the posts 262, 264. Contact (e.g., mechanical, electrical, etc.) between the respective upper and lower proximity switches and the anti-rotation rod 288 of each post 262, 264 indicates deployment of the particular post 262, 264. For example, if the anti-rotation rod 288 of a particular post 262, 264 is in contact with both the upper and lower proximity switches, that particular post 262, 264 is in a stowed position. If the anti-rotation rod 288 of a particular post 262, 264 is in contact with only the upper proximity switch, that particular post 262, 264 is in an at least partially deployed position. The charging station 12, 112, can determine if a particular post 262, 264 is deployed by doing a test of conductivity. For example, there are force sensors in the motors of the linear actuators 296 that move the posts 262, 264 up into the deployed position. If the controller 18, 118 of the charging station 12, 112, 212 receives data from the sensors that force has reached a certain value, upward movement of the posts 262, 264 stops and the controller 18, 118 of the charging station 12, 112, 212 makes a determination that a mechanical connection was established. The controller 18, 118 of the charging station 12, 112, 212 performs an electrical test on the connection, communicating with the BMS 44 of the vehicle 40, 240, and allowing a very short power signal that is checked in the vehicle 40, 240. If power and resistance of the connection matches requirements, the controller 18, 118 of the charging station 12, 112, 212 determines that a connection was established correctly and that charging of the vehicle 40, 240 may start. The charging station 12, 112, 212 may also periodically check resistance on the connection and, if disrupted, stop charging of the vehicle 40, 240 immediately. That may also occur if a high voltage leak or insulation fault is detected.

Each of the posts 262, 264 of the coupler 260 includes a power block 274 that transfers electrical power between power cable 272 and wires 278 running within the posts 262, 264. A cover 336 protects the power block 274 from coming into electrical and/or mechanical contact with wires 278 or other elements within the housing 268. The power cable 272 includes a wire running to the post 262 and a wire running to the post 264. The power blocks 274 are mechanically connected to the housing 268 by a bracket 290 with an electrical insulator 338 disposed between the power blocks 274 and the bracket 290 in order to electrically insulate the power blocks 274 from the bracket 290 and housing 268. The bracket 290 may be made from various materials including, but not limited to, steel. The power cable 272 electro-mechanically connects the power blocks 274 to the electrical power of the charging station system 10, 110. The power cable 272 enters the housing 268 through a liquid tight conduit 304. Such power blocks 274 create a link between the electrical wires leaving the rectifier 24, 124 (that are electrically connected to the power cable 272 carrying electricity to the cylindrical posts 262, 264) and the wires 278 disposed within E-chain cable carriers 276. Each E-chain cable carrier 276 protects the wires 278 as the charging post 262, 264 moves between stowed and deployed positions. Portions of the E-chain cable carrier 276 move in and out of the outer hollow cylinder 294 as the charging post 262, 264 moves between stowed and deployed positions. The power blocks 274 link the wires 278 disposed within the E-chains 276 to the power bus wires of the power cable 272 through machined copper lugs (not shown) that can tie together through screws (not shown) both the E-chains 276 and the power bus wires of the power cable 272. Both the power bus wires of the power cable 272 and the wires 278 of the E-chains 276 are protected by a suitable electrical insulator and insulator sleeves 282 follow the wires 278 along their entire path.

Each post 262, 264 includes a contact pad 284 made of a durable material capable of withstanding weather and dirt exposure and grant low contact resistance electrical connection with the in-vehicle battery interface 400. For example, the contact pad 284 may be made from graphite or other suitable material. The wires 278 are electro-mechanically connected to the contact pad 284. FIGS. 6-11 illustrate an upper portion of the contact pad 284 as a circular element (e.g., a disk-shaped element). However, the contact pad 284 can be any desired shape including, without limitation, rectangular, square, triangular, or the like. Copper may be used for cable material and for interconnecting lugs. A seal 310 is disposed between the top end of the inner hollow cylinder 292 and the contact pad 284 in order to prevent contaminants from entering the inner hollow cylinder 292. An outer diameter of the contact pad 284 creates a radial lip 312. Similarly, the grounding post 270 includes a contact pad 324 made of a durable material capable of withstanding weather and dirt exposure and grant low contact resistance electrical connection with the in-vehicle battery interface 400. For example, the contact pad 324 may be made from graphite or other suitable material. FIGS. 6-11 illustrate an upper portion of the contact pad 324 as a circular element (e.g., a disk-shaped element). However, the contact pad 324 can be any desired shape including, without limitation, rectangular, square, triangular, or the like. Copper may be used for cable material and for interconnecting lugs. A seal is disposed between the top end of the inner hollow cylinder 314 and the contact pad 324 in order to prevent contaminants from entering the inner hollow cylinder 314. An outer diameter of the contact pad 324 creates a radial lip 326.

The in-ground coupler posts 262, 264 and housing 268 are protected by a plate 286. The plate 286 may be made from various materials including, but not limited to, steel. The plate 286 supports the coupler posts 262, 264 and protects the in-ground housing 268 allowing vehicles 240C, 240D to drive over the housing 268 safely. A bottom portion 328 of the radial lip 312 of the contact pad 284 generally contacts a top surface of the plate 286 when the charging post 262, 264 is in a generally stowed position. Similarly, a bottom portion of the radial lip 326 of the contact pad 324 generally contacts a top surface of the plate 286 when the grounding post 270 is in a generally stowed position. The upper disk-portions of the contact pads 284, 324 are above the plate 286. Alternatively, the openings in the plate 286 may be sized and shaped so as to receive the upper disk-portions of the contact pads 284, 324 within the plate 286 such that a top surface of the upper disk-portions of the contact pads 284, 324 is generally continuous with a top surface of the plate 286.

The housing 268 includes a control cable 330, wire way 332, and terminal blocks 334. The control cable 330 provides communication between the charging station 12, 112, 212 and the in-ground charging coupler 260. The control cable 330 also supplies operation power to the in-ground charging coupler 260. The wire way 332 provides electro-mechanically interconnects the control cable 330 and terminal blocks 334. The terminal blocks 334 distribute power to the linear actuators 296, 318 and/or sensors and collect signals (e.g., signals between the charging station 12, 112, 212 and various components of the in-ground coupler 260 pass through the terminal blocks 334). The charging station 12, 112 controls deployment of the charging posts 262, 264, and the charging of the electric vehicle 40, 240. The charging station 12, 112 may move the charging posts 262, 264 between stowed and deployed positions individually, or together.

The electric vehicle 40, 240 includes a charge receptacle or battery interface 400 for receiving electrical energy from the charging connector 260. The battery interface 400 is electrically connected (not shown for clarity) to the battery pack 46 of the electric vehicle 40, 240. The battery interface 400 includes a housing 404, and a pair of contact plates or pads 406, with one serving as the positive terminal and the other serving as the negative terminal. Each contact pad 406 is electrically connected to a bus bar 408 which extends out of the housing 404. The battery interface 400 also includes an earth contact pad (earth contact plate) or ground terminal pad 402 that is electrically connected to an earth wire 410. The contact pads 406, and earth contact pad 402 may be made from various electrically-conductive materials including, without limitation, copper.

The housing 404 also includes an aperture 412 on a bottom side (e.g., the side facing the charging connector 260) of the housing 404 beneath the contact pads 406 and the earth contact pad 402. The aperture 412 allows the charging posts 262, 264 and ground post 270 to enter the interior of the housing 404. The aperture 412 is shown as being generally rectangular but may be sized and/or shaped as desired. The housing also includes an access plate or door 414 slidably movable between open and closed positions. Access to the interior of the housing 404 by the pads 406, 402 through the aperture 412 is blocked when the door 414 is in the generally closed position, and the pads 406, 402 are able to access the interior of the housing 404 through the aperture 412 when the door 414 is in the generally closed position. The access plate or door 414 is controlled by the BMS 44 or other on-board control module of the vehicle 40, 240 that communicates directly or indirectly with the charging station 12, 112, 212. The opening and closing of the access plate or door 414, as seen in the figures, is only one example of how this can be achieved. Alternatively, there can be other types of doors that can open and close by other methods. In a further alternative, there could be no access plate or door at all, just conducting pads 406, 402.

The access plate or door 414 slidably moves along a track (not shown) between then open and closed positions. The door 414 is connected to a belt 416 by one or belt clamps. The belt 416 is connected about a pair of pulleys 418 (an idler pulley and a belt pulley). The belt pulley is operationally connected to a shaft 422 of a motor (not shown) which turns the belt pulley, which in turn opens and closes the access plate or door 414.

In use, the charging station system 10, 110, 210 operates when an EV 40 comes within proximity of a charging station 12, 112. Proximity to the charging station 12, 112 includes, without limitation, geographic proximity, wireless communications range, or the like. A user (e.g., a driver) of the EV 40, 240 can initiate communication with the charging station system 10, 110, 210 (e.g., by pressing a button within the EV 40, 240 or otherwise taking action to initiate wireless communication with the charging station system 10, 110, 210 including, but not limited to setting controls within the EV 40 such that the EV 40 is configured to automatically seek out wireless communication with a particular or any charging station system 10, 110, 210 within a certain proximity). Alternatively, controls within the charging station system 10, 110, 210 may be configured such that the charging station system 10, 110, 210 is configured to automatically seek out wireless communication with a particular EV 40, 240 (e.g., an EV 40, 240 that is registered with the charging station system 10, 110, 210) or any EV 40, 240 within a certain proximity of the charging station system 10, 110, 210 such that the user (or EV 40, 240 if configured to do so) can accept/decline wireless communication with the charging station system 10, 110, 210; etc.).

Communication between the charging station system 10, 110, 210 and the EV 40, 240 allows the charging station system 10, 110, 210 to determine information relevant to charging (e.g., charge of the batteries/battery pack of the EV 40, 240; temperature of the batteries/battery pack of the EV 40, 240; make/model of the EV 40, 240; charging parameters of the EV 40, 240; the type of interface(s) on the EV 40, 240 available for charging; the presence of an autonomous parking/driving system on the EV 40, 240, and whether the autonomous parking/driving system is compatible with the charging station system 10, 110, 210 such that the EV 40 240 can be guided to a particular charging station 12, 112, 212; payment information (e.g., credit card; debit card; “gas card”; or an account registered with the charging station system 10, 110, 210); etc.).

The EV 40, 240 is positioned in close proximity to a particular charging station 12, 112, 212. The EV 40, 240 can be manually positioned in close proximity to the particular charging station 12, 112, 212 by the user parking the EV 40, 240 next to that charging station 12, 112, 212. Alternatively, the EV 40, 240 can auto-park itself next to the particular charging station 12, 112, 212 due to communication between the EV 40, 240 and the charging station system 10, 110, 210 (e.g., by the charging station system 10, 110, 210 providing parking instruction to the EV 40, 240 with regard to a particular charging station 12, 112, 212; by the charging station system 10, 110, 210 taking control of the EV 40, 240 to auto-park the EV 40, 240 next to a particular charging station 12, 112, 212; etc.).

The EV 40, 240 and the charging station system 10, 110, 210 remain in operational communication by wired and/or wireless connection, and the charging station system 10, 110, 210 monitors vehicle-specific parameters including, but not limited to, battery state of charge, temperature, power demand, and the like. At some point, the charging station system 10, 110, 210 has made connection with a MV grid (e.g. 5 kV˜35 kV) in preparation for charging the EV 40, 240.

The user selects a desired charging mode (e.g., CC/CV, pulse charging, etc.). The charging mode can be manually selected by the user at the charging station 12, 112, 212 via a user interface (e.g., a graphical user interface that may include a touchscreen for selection of displayed options or a screen displaying options associated with particular buttons on the charging station 12, 112, 212; etc.). Alternatively, the desired charging mode can be manually selected by the user on a user interface within the EV 40, 240 (e.g., a graphical user interface that may include a touchscreen for selection of displayed options or a screen displaying options associated with particular buttons within the EV 40, 240; etc.). In the alternative, if the EV 40, 240 is registered with the charging station system 10, 110, 210, a preferred charging mode (along with other preferences (e.g., payment)) may be stored in the charging station system 10, 110, 210, and automatically selected by the charging station system 10, 110, 210. Once the charging mode is selected, the charging station system 10, 110, 210 configures the charging station 12, 112, 212 to charge the EV 40, 240 according to the selected charging mode, via an appropriate charging mechanism (e.g., charging cable; in-ground connector; etc.) associated with the charging station 12, 112, 212. Each make/model of electric vehicle 40, 240 has unique, vehicle-specific requirements including, but not limited to, a vehicle-specific rate of charge, a vehicle-specific capacity of charge to the electric vehicle battery, etc.

As discussed above, the charging station 12, 112, 212 includes one or more charging cables 250. If the EV 40, 240 is to be charged using a charging cable, the user plugs an appropriate charging cable 250 (e.g., a charging cable associated with the make/model of the EV 40, 240) into a mating receptacle 252 located on the EV 40, 240 for receiving electrical charge. The mating receptacle 252 is in electro-mechanical communication with the batteries/battery pack 46. The controller 18, 118 determines there is proper electro-mechanical engagement of the charging cable 250 and mating receptacle 252, monitors, and/or adjusts charging of the batteries/battery pack 46 during the charging process.

In the alternative, the EV 40, 240 may be configured for being charged by an in-ground charging connector or conductive coupler 260 in electro-mechanical communication with the charging station 12, 112, 212 to deliver electrical power from the electrical grid 34, 134 to the batteries/battery pack 46. An auto-park feature positions the EV 40, 240 over the coupler 260 so that the in-ground coupler 260 may be aligned a battery interface or receptacle 400 on the bottom of the EV 40, 240. As seen in FIG. 4A, one vehicle 240C is already positioned over a coupler 260, and the other vehicle 240D is positioned by a starting line 280 (either manually by the driver of the vehicle or by other means such as an autonomous driving system). The charging station system 210 then positions the vehicle 240D over the coupler 260, aligning the coupler 260 with the battery interface/charging receptacle on the bottom of the vehicle 240D, as seen in FIG. 4B. The in-ground coupler 260 is configured such that the cylindrical posts 262, 264, and ground post 270 of the in-ground coupler 260 move upwards to plug into or otherwise electro-mechanically engage the battery interface/charging receptacle 400 on the bottom of the vehicle 240D such that electrical charge may be transferred to the batteries/battery pack 46. However, before the posts 262, 264, 270 engage the battery interface or charging receptacle 400, the controller 18, 118 signals the EV 240C, 240D to open the access plate or door 414 of the charging receptacle 400 so that the posts 262, 264, 270 may access the interior of the housing 404 of the battery interface 400 and engage the pads 406, 402. The controller 18, 118 determines there is proper electro-mechanical engagement of the charging coupler 260 and EV 240C, 240D, monitors, and/or adjusts charging of the batteries/battery pack 46 during the charging process.

The charging station system 10, 110, 210 charges the vehicle 40, 240 until the controller 18, 118 indicates the batteries/battery pack 46 have been charged. Once charging is complete, the vehicle 40, 240 is electro-mechanically disengaged from the charging station 12, 112, 212. In the case of the charging connector 260, the posts 262, 264, 270 are disengaged from the pads 406, 402 and moved into the stowed position. Data regarding the charging can be exchanged between the charging station system 10, 110, 210 and the vehicle 40, 240 during and/or after charging. The charging station system 10, 110, 210 communicates with the vehicle 40, 240 to monitor the charging process. Once charging is complete, payment can be made for that charging by prompting the driver for a method of payment or recording the transaction with an account registered to the driver of the vehicle for subsequent invoicing/payment.

Although the present invention has been discussed above in connection with use on an electric or hybrid automobile, the present invention is not limited to that environment and may also be used on other fully-electric or hybrid vehicles including, but not limited to, space vehicles, buses, trains, carts, carriages, and other means of transportation.

Likewise, the present invention is also not to be limited to use in vehicles and may be used in non-vehicle or stationary environments (e.g., machinery, mining, elevators, or any device where electrical power is required and there is no constant energy supply). Furthermore, the present invention is also not to be limited to use in connection with electric vehicles, and may be used in any environment where electrical power is required.

In addition, the claimed invention is not limited in size and may be constructed in miniature versions or for use in very large-scale applications in which the same or similar principles of energy charging and/or storage as described above would apply. Likewise, the dimensions of the charging station system is not to be construed as drawn to scale, and that the dimensions of the charging station system may be adjusted in conformance with the area available for its placement. Furthermore, the figures (and various components shown therein) of the specification are not to be construed as drawn to scale.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the disclosure to achieve one or more of the desired objects or results.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Spatially relative terms, such as “front,” “rear,” “left,” “right,” “inner,” “outer,” “beneath”, “below”, “lower”, “above”, “upper,” “horizontal,” “vertical” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The above description presents the best mode contemplated for carrying out the present invention, and of the manner and process of making and using it, in such full, clear, concise, and exact terms as to enable any person skilled in the art to which it pertains to make and use this invention. This invention is, however, susceptible to modifications and alternate constructions from that discussed above that are fully equivalent. Consequently, this invention is not limited to the particular embodiments disclosed. On the contrary, this invention covers all modifications and alternate constructions coming within the spirit and scope of the invention as generally expressed by the following claims, which particularly point out and distinctly claim the subject matter of the invention.

What is claimed is:

1. A charging station system for charging an electric vehicle, comprising:
a charging station including a controller configured to control charging of an electric vehicle, and an in-ground charging connector moveable between stowed and deployed configurations;
wherein the charging station is configured for connection to an MV electrical grid, wherein the controller is configured to charge a battery of an electric vehicle operationally engaging the charging station; and wherein the in-ground charging connector includes at least one charging post vertically movable between stowed and deployed positions, and wherein the at least one charging post is configured to operationally engage the electric vehicle in the deployed position to charge a battery of the electrical vehicle, and is generally disposed below a ground surface upon which the electric vehicle rests when the at least one post is in the stowed position.

2. The charging station system of claim 1, wherein the charging station is configured to auto-park the electric vehicle over the in-ground charging connector for alignment of the at least one charging post with a charging receptacle on a bottom side of the electric vehicle.

3. The charging station system of claim 1, wherein the charging connector is configured to deliver a pulse charge to the battery of the electric vehicle.

4. The charging station system of claim 1, wherein the at least one charging post includes a contact pad configured to provide low resistance engagement with the electric vehicle.

5. The charging station system of claim 1, wherein the at least charging one post comprises a first charging post configured for engagement with the electric vehicle as a positive terminal and a second charging post configured for engagement with the electrical vehicle as a negative terminal, and the charging connector further includes a ground post vertically movable between stowed and deployed positions, the ground post being configured for engagement with the electric vehicle in the deployed position as a ground terminal, and wherein the ground post is generally disposed below a ground surface upon which the electric vehicle rests in the stowed position.

6. The charging station system of claim 1, wherein the charging connector further comprises a housing within which the at least one post is disposed when the at least one post is in the stowed position.

7. The charging station system of claim 1, further comprising a charging receptacle on the electric vehicle including a positive terminal, and a negative terminal; wherein the charging receptacle is configured for engaging the at least one charging post.

8. The charging station system of claim 7, wherein the charging receptacle includes a housing having an aperture, the positive and negative terminals being disposed within the housing, and wherein the at least one charging post extends through the aperture to engage the positive and negative terminals.

9. The charging station system of claim 8, wherein the housing includes an access plate configured for moving between open and closed positions.

10. The charging station system of claim 9, wherein the access plate slidably moves along a track between then open and closed positions.

11. A method for charging an electric vehicle by a charging station for recharging an electric vehicle battery, comprising:
establishing communication between the charging station and the electric vehicle;
positioning the electric vehicle over a charging connector;
vertically deploying a charging connector to engage the electric vehicle; and
charging the electric vehicle.

12. The method of claim 11, wherein positioning the electric vehicle further comprises automatically aligning the electric vehicle with the charging station.

13. The method of claim 11, further comprising automatically aligning the charging connector with a charging receptacle on the electric vehicle; automatically engaging the charging connector with the charging receptacle; and automatically delivering power to the battery; and; automatically disengaging the charging connector from the charging receptacle when the electric vehicle battery is charged to a particular level of charge.

14. The method of claim 11, wherein establishing communication further comprises wirelessly communicating information between the electric vehicle and the charging station.

15. The method of claim 11, wherein establishing communication further comprises communicating vehicle-specific information from the electric vehicle to the charging station.

16. The method of claim 11, further comprising monitoring charge status of the electric vehicle battery.

17. The method of claim 11, wherein vertically deploying the charging connector comprises vertically moving the charging connector from a stowed position below a ground surface upon which the electric vehicle rests to a deployed position wherein the charging connector operationally engages a charging receptacle on the electric vehicle.

18. The method of claim 11, wherein charging the electric vehicle comprises delivering a vehicle-specific rate of charge and a vehicle-specific capacity of charge to the electric vehicle battery.

19. The method of claim 11, wherein the charging connector comprises a first charging post configured for engagement with a charging receptacle of the electric vehicle as a positive terminal and a second charging post configured for engagement with the charging receptacle of the electrical vehicle as a negative terminal.

20. The method of claim 19, wherein the charging connector further includes a ground post vertically movable between stowed and deployed positions, the ground post being configured for engagement with the electric vehicle in the deployed position as a ground terminal, and wherein the ground post is generally disposed below a ground surface upon which the electric vehicle rests in the stowed position.
